(19) United States
(12) Patent Application Publication
(10) Pub. No.: US 2026/0205249 A1
(43) Pub. Date: Jul. 16, 2026

(54) FREQUENCY REFERENCE POINT AND SUBCARRIER SPACING FOR CROSS-LINK INTERFERENCE RESOURCES

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 19/017,329

(22) Filed: Jan. 10, 2025

(51) Int. Cl. H04L 5/00

(52) U.S. Cl. CPC H04L 5/0057; H04L 5/0092

(57) ABSTRACT

Certain aspects of the present disclosure provide techniques for wireless communications. An example method includes obtaining a configuration or a determination rule that indicates a subcarrier spacing (SCS) and a frequency reference point associated with one or more UE-to-UE cross link interference (CLI) measurement resources comprising Layer 1 (L1) resources; and sending a channel state feedback report for CLI measurement comprising one or more measurements of the one or more CLI measurement resources based on the SCS and the frequency reference point.

### Field of the Disclosure

Aspects of the present disclosure relate to wireless communications, and more particularly, to techniques for indicating parameters for cross-link interference (CLI) resources.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes identifying a configuration or a determination rule that indicates a subcarrier spacing (SCS) and a frequency reference point associated with one or more Layer 1 (L1) UE-to-UE cross link interference (CLI) measurement resources; and sending a channel state feedback report for CLI measurement comprising one or more measurements of the one or more L1 UE-to-UE CLI measurement resources based on the SCS and the frequency reference point.

Certain aspects provide a method for wireless communications by an apparatus. The method includes sending a configuration that indicates a SCS and a frequency reference point associated with one or more L1 UE-to-UE CLI measurement resources; and obtaining a channel state feedback report for CLI measurement comprising one or more measurements of the one or more L1 UE-to-UE CLI measurement resources based on the SCS and the frequency reference point.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network entity and a UE.

FIGS. 6A, 6B, and 6C depict various example aspects of full-duplex communications.

FIGS. 7A, 7B, and 7C depict various example aspects of cross-link interference (CLI).

FIG. 8 depicts an example wireless communications network.

FIGS. 9A and 9B depict example configurations for reporting CLI feedback.

FIG. 10 depicts a process flow for communications in a network between a network entity and a UE.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for indication of parameters of cross-link interference (CLI) resources, such as a frequency reference point and subcarrier spacing (SCS) for the CLI resources.

A wireless communication network may include a number of devices and network entities employing techniques for exchanging information wirelessly. For example, a wireless communication network may include devices (e.g., user equipments (UEs)) and network entities (e.g., base stations (BSs)) that wirelessly communicate data, control information, reference signals, etc. (e.g., according to various wireless communication network implementations). The wireless communication network may employ various technologies to improve throughput, achieve a high data rate, and/or improve the energy efficiency of the wireless communication network. These technologies may allow a wireless communication network to support communication between an increasing number of devices and network entities, support advanced functionalities at various devices, and improve the quality of communication between devices and network entities.

Network entities and/or devices in a wireless communications network may experience different types of interference to their communications. As described herein, one of the types of interference that affect the communications may include CLI. For example, CLI may include first communications for a first device or first network entity experiencing interference from second communications for a second device or second network entity, where the first communications and the second communications may occur at a same time (e.g., on same time-domain resources, such as a same slot). That is, uplink communications for the first device or first network entity may cause CLI on downlink communications for the second device or second network entity. Additionally or alternatively, downlink communications for the first device or first network entity may cause CLI on uplink communications for the second device or second network entity

In some aspects, the CLI may arise due to full-duplex communications. For example, a first network entity associated with a first cell (e.g., first coverage area) may employ full-duplex communications for simultaneous transmission of downlink communications and reception of uplink communications on same time-domain resources. In the case of CLI, a second network entity associated with a second cell (e.g., second coverage area) may also employ full-duplex communications for simultaneous transmission of downlink communications and reception of uplink communications on at least a portion of the same time-domain resources, where the first cell and the second cell neighbor each other (e.g., the first network entity and the second network entity at least partially overlap and/or are in close proximity to each other). Accordingly, uplink communications sent to the first network entity may cause CLI to downlink communications sent by the second network entity, and/or uplink communications sent to the second network entity may cause CLI to downlink communications sent by the first network entity. In some aspects, the CLI caused by communications between different network entities may be referred to as inter-network entity CLI (e.g., inter-gNB CLI). Additionally or alternatively, the inter-network entity CLI may include downlink communications sent by one of the network entities causing CLI on uplink communications sent to another network entity.

Additionally or alternatively, based on the full-duplex communications, the first network entity may simultaneously obtain uplink signals from a first device in the first cell and send downlink signals to a second device in the first cell on a first set of same time-domain resources, where the uplink signals can cause CLI to the downlink signals within the first cell. In some aspects, the CLI caused by the uplink signals from the first device to the downlink signals to the second device within the first cell may be referred to as intra-cell UE-to-UE CLI and/or intra-cell inter-UE CLI. Additionally or alternatively, the second network entity may simultaneously obtain uplink signals from a third device in the second cell and send downlink signals to a fourth device in the second cell on a second set of same time-domain resources, where UE-to-UE intra-cell CLI and/or inter-UE intra-cell CLI can occur for the third device and fourth device. In some aspects, the UE-to-UE intra-cell CLI and/or inter-UE intra-cell CLI may include downlink communications sent to one of the UEs causing CLI on uplink communications sent by another UE.

In some aspects, the second set of same time-domain resources may at least partially overlap with the first set of same time-domain resources. Accordingly, the uplink signals from the third device in the second cell may also cause CLI to the downlink signals for the second device in the first cell, where this CLI may be referred to as inter-cell UE-to-UE CLI and/or inter-cell inter-UE CLI. Additionally or alternatively, the inter-cell UE-to-UE CLI and/or inter-cell inter-UE CLI may include downlink communications sent to one of the UEs causing CLI on uplink communications sent by another UE.

To mitigate CLI (e.g., intra-cell UE-to-UE CLI and/or inter-cell UE-to-UE CLI), closed-loop feedback associated with a communication channel may be used to dynamically adapt communication parameters (e.g., modulation and coding scheme (MCS), beamforming, multiple-input and multiple-output (MIMO) layers, resource allocations, transmission power, beam configurations, etc.). As an example, a UE may monitor certain measurement resources (e.g., CLI measurement resources and/or CLI resources) configured on different frequency bands and may perform measurements on the measurement resources to estimate the CLI. For example, the UE may measure or obtain a received signal strength indicator (RSSI) for estimating the CLI using CLI measurement resources configured on frequency bands configured for uplink communications, downlink communications, and/or a guard band (e.g., a frequency subband allocated between frequency bands configured for the uplink communications and frequency bands configured for the downlink communications), where the CLI measurement resources may be referred to as CLI-RSSI measurement resources. Additionally or alternatively, the UE may measure or obtain a reference signal received power (RSRP) for estimating the CLI using CLI measurement resources configured on frequency bands configured for uplink communications, where the CLI measurement resources may include sounding reference signal (SRS) transmissions (e.g., sent by a different UE) and may be referred to as CLI SRS-RSRP measurement resources and/or SRS-RSRP measurement resources.

Subsequently, the UE may send a CLI report to the network entity, where the CLI report includes the estimated CLI, measured RSSI, and/or measured RSRP. Subsequently, the network entity may adjust certain communication parameters (e.g., resource allocations for uplink and/or downlink communications, transmission power for the UE and/or other UEs, transmission power for the network entity, etc.) in response to the CLI report transmitted by the UE to mitigate and/or lessen the impacts of the CLI. This closed-loop feedback scheme may be referred to as channel state feedback, CLI feedback, and/or CLI reporting for intra-cell UE-to-UE CLI and/or inter-cell UE-to-UE CLI. In some aspects, the UE may send CLI reports to the network entity using Layer 1 (L1) signaling, which may include signaling via the physical (PHY) layer. For example, the UE may send the CLI report via uplink control information (UCI) on a physical uplink control channel (PUCCH) and/or a physical uplink shared channel (PUSCH). In some aspects, the measurement resources may also be sent via L1 signaling.

One or more technical problems arise for CLI handling (e.g., mitigating CLI) of intra-cell UE-to-UE CLI and/or inter-cell UE-to-UE CLI. For example, the UE may not know an exact frequency location and/or other parameters for the CLI measurement resources to estimate the CLI, measure the RSSI, and/or measure the RSRP. As such, the UE may monitor for the CLI measurement resources across an entire frequency band or subband based on not knowing the exact frequency location for the CLI measurement resources, which may consume extraneous processing and radio power at the UE. Additionally or alternatively, the UE may improperly estimate the CLI, measure the RSSI, and/or measure the RSRP based on not knowing the exact frequency location and/or the other parameters for the CLI measurement resources, such that the CLI report includes inaccurate estimations or measurements, which may impact the CLI handling. For example, an SCS may control and/or indicate the bandwidth of a subcarrier, among other parameters of the subcarrier. As such, signaling of the CLI measurement resources may not be intelligible at the UE with respect to the frequency domain allocation for the CLI measurement resources without a common understanding of the SCS for the CLI measurement resources between the network entity and the UE. Accordingly, if the UE is unaware of the SCS for the CLI measurement resources, the UE may be unable to accurately estimate the CLI, measure the RSSI, and/or measure the RSRP using the CLI measurement resources because the signaling of the CLI measurement resources is not intelligible at the UE and/or the UE is unaware how the CLI measurement resources are spaced or allocated in the frequency domain. Subsequently, the network entity may not adjust communication parameters to successfully handle or mitigate the CLI based on the inaccurate CLI estimation, RSSI measurements, and/or RSRP measurements.

The techniques and apparatuses described herein provide a technical solution for CLI handling of intra-cell UE-to-UE CLI and/or inter-cell UE-to-UE CLI. For example, a UE may identify (e.g., determine and/or obtain) a configuration or a determination rule of a frequency reference point and an SCS for CLI measurement resource(s). In some aspects, the UE may determine (e.g., according to the configuration and/or the determination rule) the SCS for the CLI measurement resource(s) based on an SCS of an active downlink bandwidth part (BWP), an active uplink BWP, or a reference downlink BWP. Additionally or alternatively, a network entity may configure the SCS for the CLI measurement resource(s) and may indicate the configured SCS to the UE in an information element (IE) that defines and/or configures the CLI measurement resource(s). The UE may also determine (e.g., according to the configuration and/or the determination rule) the frequency reference point for the CLI measurement resource(s) based on a first or starting resource block (RB) of the active downlink BWP, a first or starting RB of the reference downlink BWP, or a first or starting common resource block on a common resource block grid. A frequency reference point may be a reference point for finding a first RB or first physical RB (PRB) of the CLI measurement resource(s) for measuring the CLI, RSSI, and/or RSRP. For example, the network entity may configure (e.g., and indicate to the UE) a starting RB index and/or frequency offset value for the CLI measurement resource(s) in the IE that defines and/or configures the CLI measurement resource(s), where the starting RB index and/or frequency offset value is in relation to the determined frequency reference point.

In some aspects, the network entity may define the CLI measurement resource(s) (e.g., in the IE) per downlink BWP, for a reference downlink BWP, and/or per cell. That is, the network entity may indicate a respective IE per downlink BWP of a plurality of downlink BWPs, where the respective IEs define the CLI measurement resource(s) in each downlink BWP, or the network entity may indicate one IE for a reference downlink BWP to define the CLI measurement resource(s) in the reference downlink BWP. Alternatively, the network entity may indicate an IE for a given cell to define the CLI measurement resource(s) in an active downlink BWP of the given cell, where the IE is included under an additional IE that defines configuration parameters for the given cell.

In some aspects, the UE may monitor for the CLI measurement resource(s) on a same cell that the UE obtains a report configuration for the CLI report. For example, if the UE obtains the report configuration for the CLI report via a first cell, then the UE may also monitor for the CLI measurement resources via the first cell (e.g., using the determined or configured frequency reference point and SCS for the CLI measurement resources as described above). Additionally or alternatively, the UE may monitor for the CLI measurement resource(s) on a different cell that the UE obtains a report configuration for the CLI report. For example, the UE may obtain the report configuration for the CLI report via a first cell, where the report configuration includes a carrier parameter that indicates a second cell for the CLI measurement resources. Accordingly, the UE may monitor for the CLI measurement resources via the second cell (e.g., using the determined or configured frequency reference point and SCS for the CLI measurement resources as described above).

In certain aspects, certain techniques for identifying (e.g., determining and/or obtaining) a configuration or a determination rule of a frequency reference point and an SCS for CLI measurement resource(s) as described herein may provide any of various beneficial effects and/or advantages for CLI handling. For example, a UE may identify a configuration or a determination rule of the frequency reference point for the CLI measurement resource(s), thereby enabling the UE to accurately identify where the CLI measurement resource(s) are located in frequency. Accordingly, the UE may reduce power consumption by accurately identifying the frequency location of the CLI measurement resource(s) rather than having to blindly monitor for the CLI measurement resource(s) across a wider frequency band. Additionally, the UE may identify a configuration or a determination rule of the SCS for the CLI measurement resource(s) to enable the UE to determine how the CLI measurement resource(s) are spaced or allocated in the frequency domain. Accordingly, the UE may accurately estimate and report the CLI to a network entity based on the determined or configured SCS for the CLI measurement resource(s), which may enable the network entity to successfully mitigate and/or lessen the effects of the accurately estimated CLI.

As described previously, the UE may monitor for and measure the CLI measurement resource(s) (e.g., according to the determined and/or obtained frequency reference point and SCS) on a same cell that the UE obtains a report configuration for the CLI report. In some such aspects, the UE may accurately measure and report intra-cell UE-to-UE CLI to the network entity, such that the network entity can successfully mitigate and/or lessen the effects of the intra-cell UE-to-UE CLI. Additionally or alternatively, the UE may monitor for the CLI measurement resource(s) (e.g., according to the determined and/or obtained frequency reference point and SCS) on a different cell that the UE obtains a report configuration for the CLI report. In some such aspects, the UE may accurately measure and report inter-cell UE-to-UE CLI to the network entity, such that the network entity can successfully mitigate and/or lessen the effects of the inter-cell UE-to-UE CLI.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

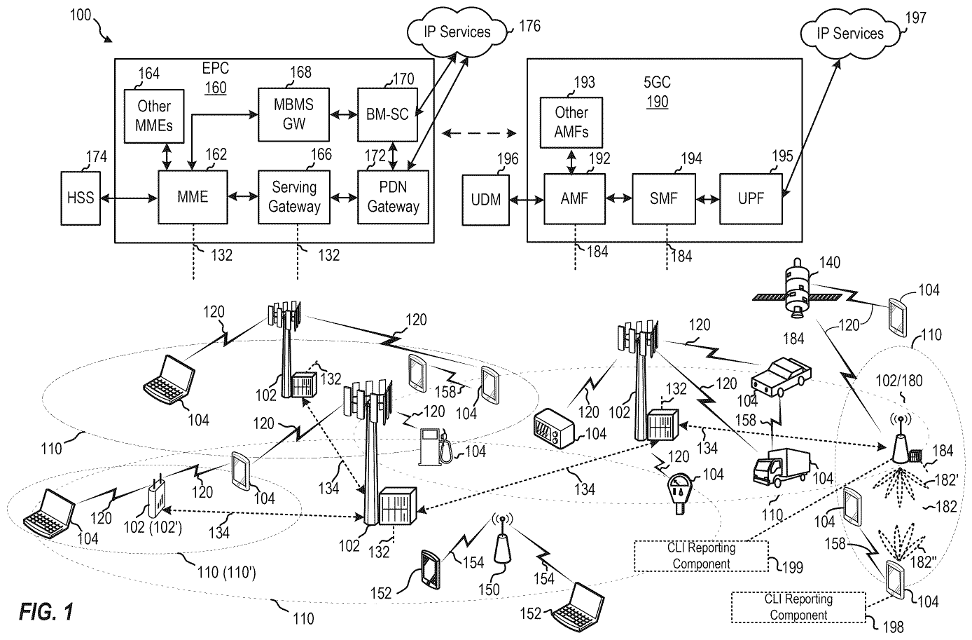

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

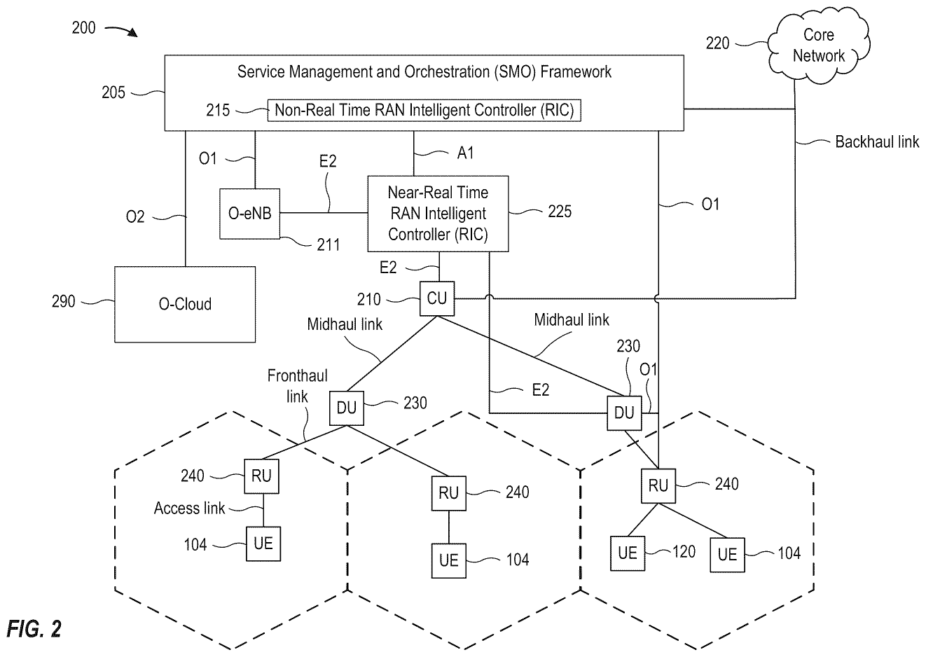

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHZ, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes a CLI reporting component 198, which may be used to determine and/or obtain a configuration of a frequency reference point and an SCS for CLI measurement resource(s) to report CLI feedback as further described herein. Further, a base station 102 includes a CLI reporting component 199, which may be used to implicitly or explicitly indicate a frequency reference point and an SCS for CLI measurement resource(s) to enable CLI feedback reporting as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

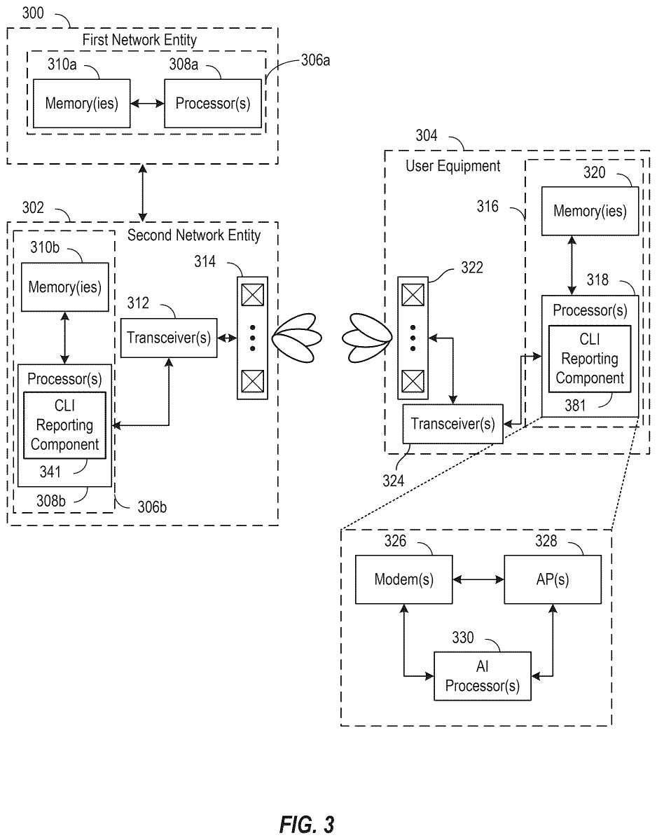

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory (ies) 310a” and “memory (ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

In the depicted example, the processor(s) 308b includes a CLI reporting component 341, which may be representative of the CLI reporting component 199 of FIG. 1. Notably, while depicted as an aspect of processor(s) 308b, the CLI reporting component 341 may be implemented additionally or alternatively in various other aspects of a network entity or a base station 102 in other implementations. Further, the processor(s) 318 includes a CLI reporting component 381, which may be representative of the CLI reporting component 198 of FIG. 1. Notably, while depicted as an aspect of the processor(s) 318, the CLI reporting component 381 may be implemented additionally or alternatively in various other aspects of a UE 104 in other implementations.

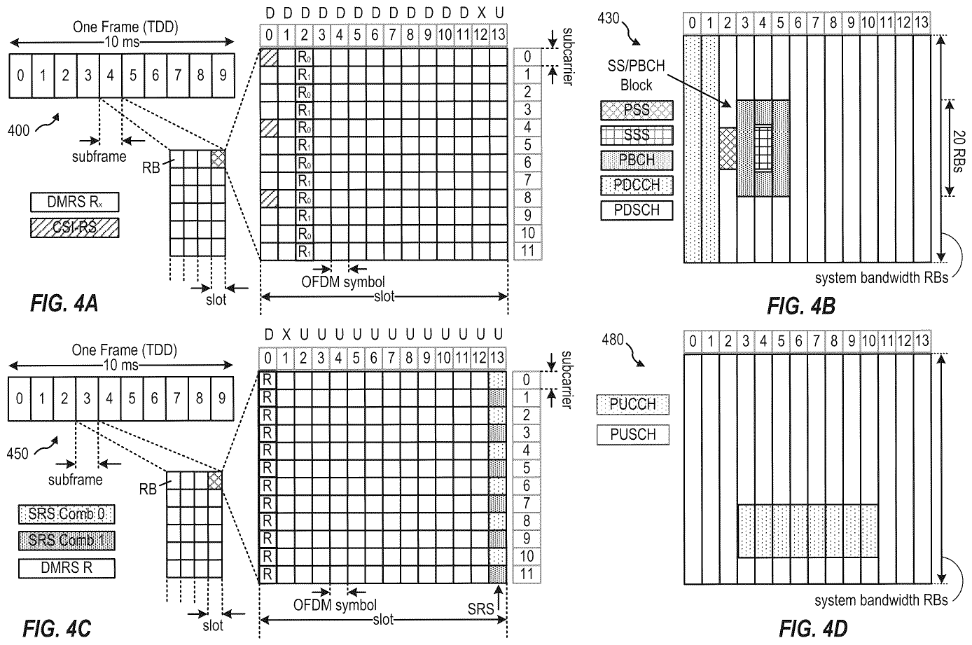

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (u) 0 to 6 may allow for 1, 2, 4, 8, 16, 32, and 64 slots, respectively, per subframe. In some cases, an extended CP (e.g., 12 symbols per slot) may be used with a specific numerology, such as numerology u=2 allowing for 4 slots per subframe. The subcarrier spacing and symbol length/duration are a function of the numerology. The subcarrier spacing may be equal to 24× 15 kHz. As an example, the numerology u=0 corresponds to a subcarrier spacing of 15 kHz, and the numerology u=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology u=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ

ACK/NACK feedback. The PUSCH carries data, and may additionally be used to carry a buffer status report (BSR), a power headroom report (PHR), and/or UCI.

### Aspects Related to Channel State Feedback

In certain wireless communication networks, closed-loop feedback associated with a communication channel between a UE and a network entity may be used to dynamically adapt communication parameters to channel conditions that may change over time. In certain cases, a UE may transmit a reference signal (e.g., DMRS, SRS, etc.), and a network entity (or another UE) may determine characteristics associated with the channel based on measurements of the received reference signal. In some cases, a UE may receive a reference signal (e.g., SSB, CSI-RS, DMRS, PT-RS, etc.) from a network entity (or another UE) and report channel state feedback to the network entity (or the other UE), where the channel state feedback is determined based on measurements of the reference signal received at the UE.

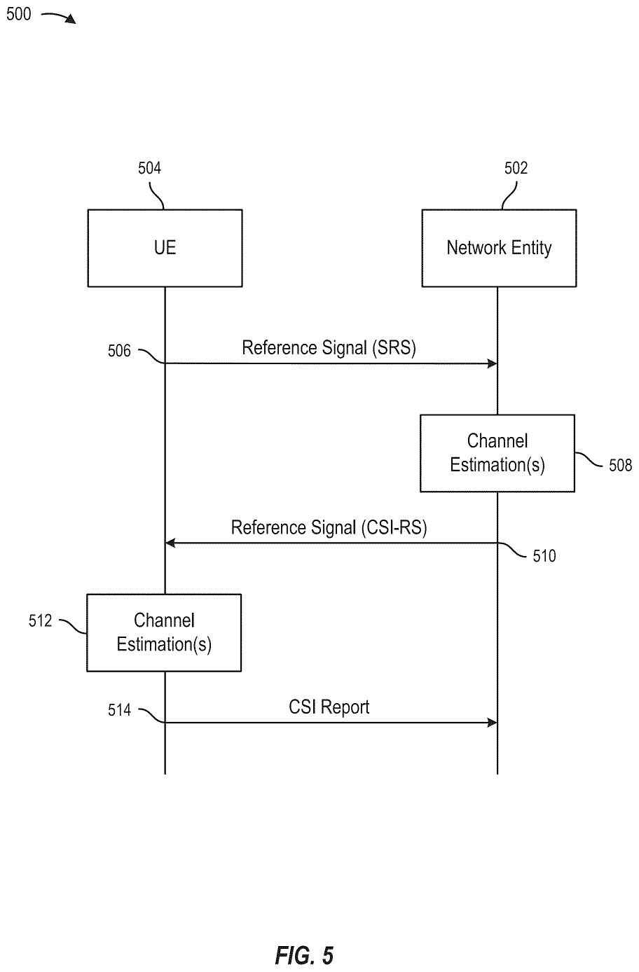

FIG. 5 depicts a process flow 500 for closed-loop feedback associated with a communication channel between a network entity 502 and a UE 504.

At 506, UE 504 sends a reference signal (e.g., SSB, CSI-RS, DMRS, PT-RS, SRS, etc.) to the network entity 502. In certain aspects, the UE 504 may send the reference signal (e.g. SRS) using one or more receive antenna ports, which may correspond to an SRS port or SRS antenna port. Transmission of the SRS via the receive antenna port may enable the network entity 502 to deduce the downlink propagation channel associated with the receive antenna port based on channel reciprocity.

At 508, the network entity 502 performs channel calculations based on the reference signal, such as determining a channel estimate H based on the received reference signal, for example, as further described herein with respect to the UE performing channel calculations at 512. In certain aspects, the network entity 502 may further calculate, as part of the channel calculations, a precoder (e.g., precoder matrix) V based on the channel estimate H, for example, as further described herein with respect to the UE 504 performing such a calculation. Accordingly, the network entity 502 may determine H and/or V for an uplink channel between UE 504 and network entity 502 based on SRS. Further, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

At 510, the UE 504 receives a reference signal (e.g., SSB, CSI-RS, etc.) from the network entity 502. In certain aspects, the network entity may send the reference signal with precoding (e.g., beamforming, MIMO layer(s), and/or compensation for signal propagation effects) based on the channel estimate and/or precoder determined at 508.

At 512, the UE 504 performs channel calculations based on the reference signal, such as determining a channel estimate H based on the received reference signal. For example, the UE 504 may include a demodulator or a baseband processor, which may be part of a modem (e.g., the modem(s) 326) of UE 504. The demodulator, such as a component of the modem, may obtain as input the reference signal as received over multiple antennas of the UE 504 and output (or determine) a vector y that is a representation of the received reference signal as received over each of the multiple antennas of the UE 504.

Based on a received signal model, the vector y can be represented as follows in equation (1):

$$\vec{y} = H \vec{x} + \vec{n} \qquad ( 1 )$$

In equation (1), H corresponds to a matrix representation of the communications channel, as in a channel estimate of the communications channel the signal is communicated in (e.g., downlink communication channel where the reference signal is communicated), x is the vector representing symbols transmitted by network entity 502 over a number of spatial layers, and n′ is noise across the communications channel. In certain aspects, H has a size equal to the number of antennas used to receive the signaling, Nant, times the number of spatial layers, NI, (e.g., the number of beamformed transmissions, number of antenna ports, etc.). For example, H has a number of rows equal to Nant and a number of columns equal to Nr. In certain aspects, the symbols that form the reference signal are known by the UE 504 (e.g., configured or preconfigured at the UE). UE 504 can determine the channel estimate H based on receiving the reference signal.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD (H)= [U S V], such that SVD provides the precoder V. U may be related to the ordering of the rows of H, as in the ordering of the antennas as represented by H. It should be understood that other suitable techniques may be used to determine the precoder V based on the channel estimate H.

At 514, UE 504 sends to the network entity 502 a CSI report indicating the determined channel estimate H and/or precoder V. For example, the UE 504 may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for downlink transmissions on the PDSCH. CQI may be an indicator of the UE's preferred modulation and coding scheme for downlink transmissions. The UE 504 may send an indication of the one or more determined CSI parameters to the network entity 502 in the CSI report. The network entity 502 may schedule downlink data transmissions to the UE 504 accordingly, such as using an MCS, code rate, number of MIMO layers, or the like, that the network entity determines based on the CSI report.

### Aspects Related to Full-Duplex Communications

In certain wireless communication networks, devices may employ full-duplex communications to increase throughput. For example, a network entity may employ full-duplex communications for simultaneous transmission of downlink communications and reception of uplink communications on same time-domain resources. As such, the network entity may increase throughput by simultaneous communicating in the downlink and the uplink on the same time-domain resources rather than communicating in either the downlink or the uplink at a given time. In some aspects, a UE may also employ full-duplex communications for simultaneous reception of downlink communications and transmission of uplink communications on same time-domain resources to increase throughput at the UE.

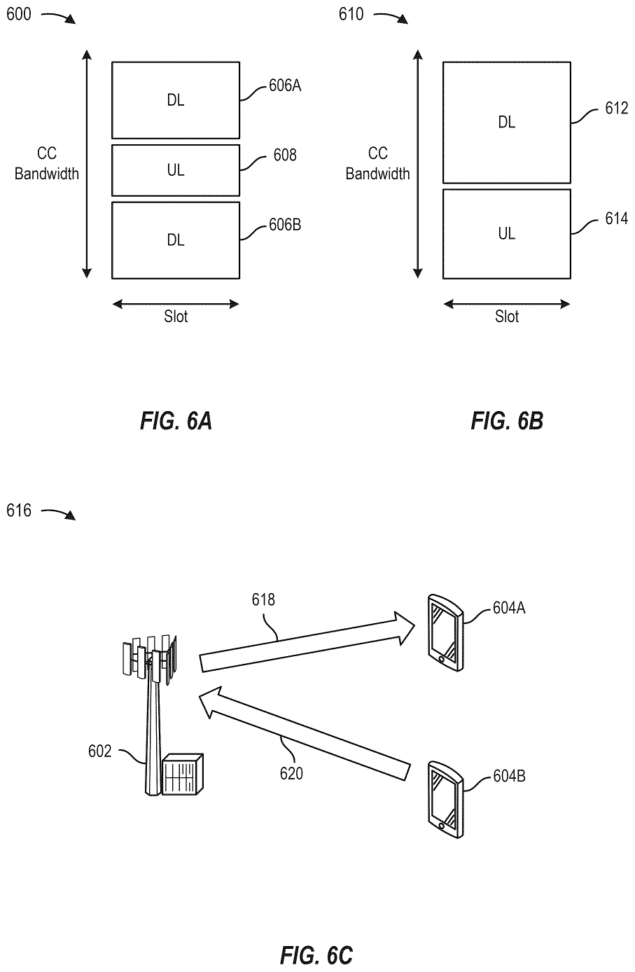

FIG. 6A depicts an example of a first full-duplex communications configuration 600, and FIG. 6B depicts another example of a second full-duplex communications configuration 610. In some examples, the first full-duplex communications configuration 600 and the second full-duplex communications configuration 610 may implement aspects of or may be implemented by aspects of FIGS. 1-5. For example, a network entity and/or a UE may employ full-duplex communications according to the first full-duplex communications configuration 600 or the second full-duplex communications configuration 610. In some aspects, the network entity may be an example of the BS 102 depicted and described with respect to FIG. 1, the first network entity 300 or the second network entity 302 depicted and described with respect to FIG. 3, a disaggregated base station depicted and described with respect to FIG. 2, or the network entity 502 depicted and described with respect to FIG. 5. Similarly, the UE may be an example of the UE 104 depicted and described with respect to FIG. 1, the UE 304 depicted and described with respect to FIG. 3, or the UE 504 depicted and described with respect to FIG. 5.

In some aspects, the first full-duplex communications configuration 600 and the second full-duplex communications configuration 610 may represent configurations for subband full-duplex (SBFD) communications in a TDD carrier or an intra-band CA-based scenario. For example, the first full-duplex communications configuration 600 and the second full-duplex communications configuration 610 may support simultaneous transmission and reception of downlink and uplink communications on a subband basis using non-frequency-overlapped subbands. That is, the downlink and uplink communications in the first full-duplex communications configuration 600 and the second full-duplex communications configuration 610 may occur within subbands of a same CC bandwidth.

In the example of FIG. 6A, the first full-duplex communications configuration 600 may include a first subband 606A (e.g., a first frequency allocation) and a second subband 606B (e.g., a second frequency allocation) configured for downlink communications and a third subband 608 (e.g., a third frequency allocation) configured for uplink communications, where the first subband 606A, the second subband 606B, and the third subband 608 are located within a same CC bandwidth and are non-overlapped with one another. In some aspects, respective guard bands may be configured between the first subband 606A and the third subband 608 and between the second subband 606B and the third subband 608. In the example of FIG. 6B, the second full-duplex communications configuration 610 may include a first subband 612 configured for downlink communications and a second subband 614 configured for uplink communications, where the first subband 612 and the second subband 614 are located within a same CC bandwidth. In some aspects, a guard band may be configured between the first subband 612 and the second subband 614.

In some aspects, a network entity may determine which full-duplex communications configuration to use based on an amount of uplink communications and/or an amount of downlink communications that are expected to occur. For example, the third subband 608 configured for uplink communications in the first full-duplex communications configuration 600 may be smaller than the second subband 614 configured for uplink communications in the second full-duplex communications configuration 610. Similarly, the combination of the first subband 606A and the second subband 606B configured for downlink communications in the first full-duplex communications configuration 600 may be larger than the first subband 612 configured for downlink communications in the second full-duplex communications configuration 610. Accordingly, if a smaller amount of uplink communications and/or a larger amount of downlink communications are expected, the network entity may determine to use the first full-duplex communications configuration 600 for the full-duplex communications. Additionally or alternatively, if a larger amount of uplink communications and/or a smaller amount of downlink communications are expected, the network entity may determine to use the second full-duplex communications configuration 610 for the full-duplex communications. This may also be based on capabilities of UEs served by the network entity, such as whether the UEs support full-duplex communication, SBFD communication, or only half-duplex communication.

In some aspects, the network entity may dynamically switch between the first full-duplex communications configuration 600 and the second full-duplex communications configuration 610 based on the amount of uplink communications and/or the amount of downlink communications that are expected to occur. Additionally or alternatively, the network entity may determine which full-duplex communications configuration to use and/or to dynamically switch between the first full-duplex communications configuration 600 and the second full-duplex communications configuration 610 based on other factors than the amount of uplink communications and/or the amount of downlink communications that are expected to occur and/or the UE capabilities.

Based on the first full-duplex communications configuration 600 and the second full-duplex communications configuration 610, an uplink duty cycle (e.g., an amount of time allocated for the uplink communications) may be increased compared to scenarios where the downlink communications and the uplink communications occur separately in time. Accordingly, the increased uplink duty cycle may lead to latency reduction and uplink coverage improvements. For example, the latency may be reduced for the uplink communications based on the increased uplink duty cycle because the uplink communications can occur in the subbands configured for the uplink communications even if the subbands are located in downlink slots (e.g., slots configured for downlink communications alone) and/or flexible slots (e.g., slots that can be configured for either downlink communications or uplink communications), thereby increasing the amount of time allocated for the uplink communications and enabling uplink latency savings. Similarly, uplink coverage may be improved for the uplink communications based on the increased uplink duty cycle because a greater amount of time is available for the uplink communications.

Additionally, the first full-duplex communications configuration 600 and the second full-duplex communications configuration 610 may enhance system capacity, resource utilization, and/or spectrum efficiency by supporting both the downlink communications and the uplink communications on the same time-domain resources. That is, separate time-domain resources may not be configured for the downlink communications and for the uplink communications, thereby enhancing system capacity, resource utilization, and/or spectrum efficiency. Additionally, as described previously, the first full-duplex communications configuration 600 and the second full-duplex communications configuration 610 may enable flexible and dynamic uplink/downlink resource adaption according to expected uplink/downlink traffic (e.g., the amount of uplink communications and/or the amount of downlink communications that are expected to occur) in a robust manner. That is, the flexible and dynamic uplink/downlink resource adaption may allocate larger or smaller amounts of resources for the downlink communications and/or the uplink communications based on the expected uplink/downlink traffic, such that extraneous or insufficient resources are mitigated for the downlink communications and/or the uplink communications, leading to increased throughput and enhanced resource utilization.

FIG. 6C depicts an example of a full-duplex communications scenario 616. In some examples, the full-duplex communications scenario 616 may implement aspects of or may be implemented by aspects of FIGS. 1-5. For example, the full-duplex communications scenario 616 may include a network entity 602, a first UE 604A, and a second UE 604B. In some aspects, the network entity 602 may be an example of the BS 102 depicted and described with respect to FIG. 1, the first network entity 300 or the second network entity 302 depicted and described with respect to FIG. 3, a disaggregated base station depicted and described with respect to FIG. 2, or the network entity 502 depicted and described with respect to FIG. 5. Similarly, the UEs 604 may be examples of the UE 104 depicted and described with respect to FIG. 1, the UE 304 depicted and described with respect to FIG. 3, or the UE 504 depicted and described with respect to FIG. 5.

In the example of FIG. 6C, the network entity 602 of the full-duplex communications scenario 616 may be a full-duplex network entity (e.g., full-duplex gNB), such that the network entity 602 supports transmission of downlink communications 618 and reception of uplink communications 620 on same time-domain resources (e.g., within a same slot). For example, the network entity 602 may support the downlink communications 618 with the first UE 604A and the uplink communications 620 with the second UE 604B being performed simultaneously. In some aspects, the downlink communications 618 and the uplink communications 620 may occur according to the first full-duplex communications configuration 600 or the second full-duplex communications configuration 610 depicted and described with respect to FIGS. 6A and 6B, respectively.

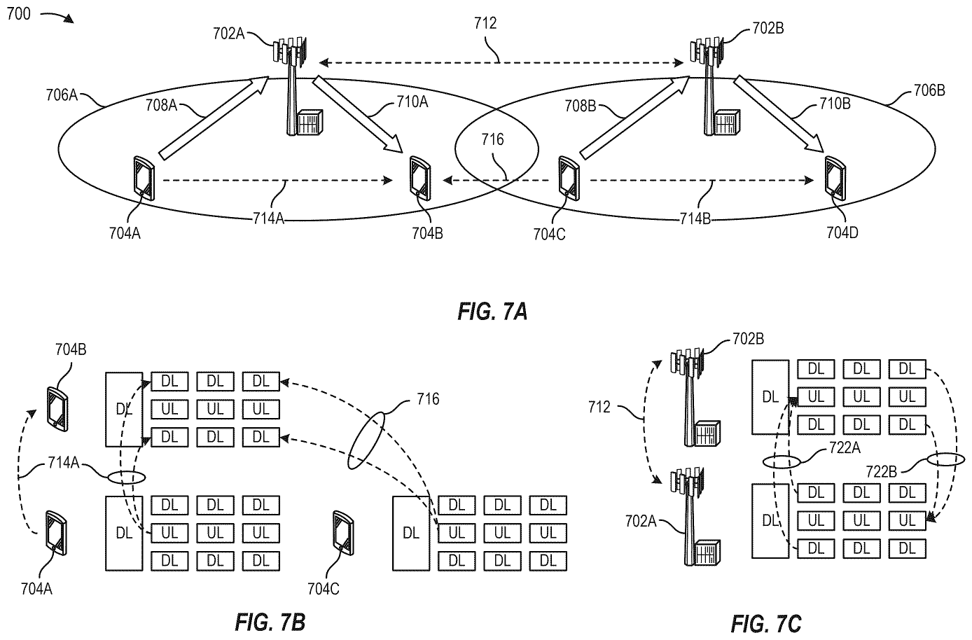

However, as described herein, the full-duplex communications scenario 616 may lead to CLI based on the downlink communications 618 and the uplink communications 620 occurring at a same time (e.g., on same time-domain resources). For example, the uplink communications 620 may cause CLI on the downlink communications 618, and/or the downlink communications 618 may cause CLI on the uplink communications 620. CLI that arises due to full-duplex communications is described in greater detail with reference to FIGS. 7A-7C.

### Aspects Related to CLI Caused By Full-Duplex Communications

FIG. 7A depicts a wireless communications network 700 that includes various examples of CLI. In some examples, the wireless communications network 700 may implement aspects of or may be implemented by aspects of FIGS. 1-6C. For example, the wireless communications network 700 may include a first network entity 702A, a second network entity 702B, a first UE 704A, a second UE 704B, a third UE 704C, and a fourth UE 704D. In some aspects, the network entities 702 may be examples of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIG. 5, or the network entity 602 depicted and described with respect to FIG. 6. Similarly, the UEs 704 may be examples of the UE 104 depicted and described with respect to FIG. 1, the UE 304 depicted and described with respect to FIG. 3, the UE 504 depicted and described with respect to FIG. 5, or the UEs 604 depicted and described with respect to FIG. 6.

The first network entity 702A may support communications in a first coverage area 706A, and the second network entity 702B may support communications in a second coverage area 706B, where the first coverage area 706A and the second coverage area 706B may represent examples of the coverage area 110 depicted and described with respect to FIG. 1. In some aspects, the first coverage area 706A may include and/or may be referred to as a first cell, and the second coverage area 706B may include and/or may be referred to as a second cell. The first UE 704A and the second UE 704B may be located within the first coverage area 706A, and the third UE 704C and the fourth UE 704D may be located within the second coverage area 706B. Accordingly, the first network entity 702A may communicate with the first UE 704A and the second UE 704B located within the first coverage area 706A, and the second network entity 702B may communicate with the third UE 704C and the fourth UE 704D located within the second coverage area 706B.

In some aspects, both the first network entity 702A and the second network entity 702B may support full-duplex communications (e.g., as depicted and described with respect to FIGS. 6A-6C). For example, the first network entity 702A may simultaneously communicate with the first UE 704A and the second UE 704B on a first set of same time-domain resources, and the second network entity 702B may simultaneously communicate with the third UE 704C and the fourth UE 704D on a second set of same time-domain resources. That is, the first network entity 702A may support first uplink communications 708A with the first UE 704A and first downlink communications 710A with the second UE 704B, where the first uplink communications 708A and the first downlink communications 710A occur on the first set of same time-domain resources. Similarly, the second network entity 702B may support second uplink communications 708B with the third UE 704C and second downlink communications 710B with the fourth UE 704D, where the second uplink communications 708B and the second downlink communications 710B occur on the second set of same time-domain resources.

As described previously, the full-duplex communications of the first network entity 702A and the second network entity 702B may cause different types of CLI. For example, an inter-network entity CLI 712 (e.g., inter-gNB CLI) may occur between the first network entity 702A and the second network entity 702B based on the full-duplex communications. The inter-network entity CLI 712 is depicted and described in greater detail with respect to FIG. 7C. Additionally or alternatively, an intra-cell UE-to-UE CLI 714 (e.g., intra-cell inter-UE CLI) may occur between the UEs 704 based on the full-duplex communications. For example, a first intra-cell UE-to-UE CLI 714A may occur between the first UE 704A and the second UE 704B, and a second intra-cell UE-to-UE CLI 714B may occur between the third UE 704C and the fourth UE 704D. In some aspects, an inter-cell UE-to-UE CLI 716 (e.g., inter-cell inter-UE CLI) may occur between UEs 704 located in different coverage areas 706 (e.g., different cells) based on the full-duplex communications. For example, the inter-cell UE-to-UE CLI 716 may occur between the third UE 704C located in the second coverage area 706B (e.g., the second cell) and the second UE 704B located in the first coverage area 706A (e.g., the first cell). The intra-cell UE-to-UE CLI 714 and the inter-cell UE-to-UE CLI 716 are depicted and described in greater detail with respect to FIG. 7B.

In some aspects, the full-duplex communications of the first network entity 702A and the second network entity 702B may include SBFD communications as depicted and described with respect to FIGS. 6A and 6B. Accordingly, when the full-duplex communications include SBFD communications, the inter-network entity CLI 712 may be referred to as inter-SB inter-network entity CLI (e.g., inter-SB inter-gNB CLI). Similarly, the intra-cell UE-to-UE CLI 714 may be referred to as inter-SB intra-cell UE-to-UE CLI (e.g., inter-SB intra-cell inter-UE CLI), and the inter-cell UE-to-UE CLI 716 may be referred to as inter-SB inter-cell UE-to-UE CLI (e.g., inter-SB inter-cell inter-UE CLI). That is, the different types of CLI may occur between different subbands allocated and/or configured for the uplink communications 708 and for the downlink communications 710. Additionally or alternatively, the full-duplex communications of the first network entity 702A and the second network entity 702B may include partial or fully overlapped full-duplex communications, where the uplink communications 708 and for the downlink communications 710 occur in same frequency subbands, same frequency bands, overlapping frequency subbands, and/or overlapping frequency bands.

FIG. 7B depicts examples of the intra-cell UE-to-UE CLI 714 and the inter-cell UE-to-UE CLI 716 depicted and described with respect to FIG. 7A. For example, the first intra-cell UE-to-UE CLI 714A between the first UE 704A and the second UE 704B may occur from the first uplink communications 708A for the first UE 704A causing CLI on the first downlink communications 710A for the second UE 704B, where the first uplink communications 708A and the first downlink communications 710A occur on the first set of same time-domain resources. Additionally, the inter-cell UE-to-UE CLI 716 may occur from the second uplink communications 708B for the third UE 704C causing CLI on the first downlink communications 710A for the second UE 704B. For example, the second uplink communications 708B may occur on the second set of same-time domain resources (e.g., as the second downlink communications 710B), and the second set of same time-domain resources may at least partially overlap with the first set of same time-domain resources, such that the second uplink communications 708B for the third UE 704C cause the inter-cell UE-to-UE CLI 716 on the first downlink communications 710A for the second UE 704B.

Additionally or alternatively, although not shown in the example of FIG. 7B, the first intra-cell UE-to-UE CLI 714A may occur from the first downlink communications 710A for the second UE 704B causing CLI on the first uplink communications 708A for the first UE 704A. Similarly, the inter-cell UE-to-UE CLI 716 may occur from the first downlink communications 710A for the second UE 704B causing CLI on the second uplink communications 708B for the third UE 704C.

FIG. 7C depicts an example of the inter-network entity CLI 712 depicted and described with respect to FIG. 7A. For example, the first uplink communications 708A and the first downlink communications 710A for the first network entity 702A may occur on the first set of same time-domain resources, and the second uplink communications 708B and the second downlink communications 710B for the second network entity 702B may occur on the second set of same time-domain resources. In some aspects, the first set of same time-domain resources may at least partially overlap with the second set of same time-domain resources. Accordingly, the first downlink communications 710A for the first network entity 702A may cause a first inter-network entity CLI 722A on the second uplink communications 708B for the second network entity 702B based on the first set of same time-domain resources at least partially overlapping with the second set of same time-domain resources. Similarly, the second downlink communications 710B for the second network entity 702B may cause a second inter-network entity CLI 722B on the first uplink communications 708A for the first network entity 702A based on the first set of same time-domain resources at least partially overlapping with the second set of same time-domain resources.

Additionally or alternatively, although not shown in the example of FIG. 7C, the first inter-network entity CLI 722A may occur from the second uplink communications 708B for the second network entity 702B causing CLI on the first downlink communications 710A for the first network entity 702A. Similarly, the second inter-network entity CLI 722B may occur from the first uplink communications 708A for the first network entity 702A causing CLI on the second downlink communications 710B for the second network entity 702A.

For CLI handling of the different types of CLI depicted and described with respect to FIGS. 7A-7C (e.g., CLI mitigation), the network entities 702 and the UEs 704 may perform a closed-loop feedback for CLI reporting as described previously. For example, the closed-loop feedback for CLI reporting may follow a similar framework as the process flow 500 depicted and described with respect to FIG. 5 for CSI feedback. In some aspects, a network entity 702 may indicate a CSI report configuration to a UE 704, but the CSI report configuration may indicate for the UE to report CLI feedback rather than or in addition to CSI feedback.

In some aspects, the UE 704 may monitor certain measurement resources (e.g., CLI measurement resources and/or CLI resources) configured on different frequency bands or subbands and may perform measurements on the measurement resources to estimate the CLI. For example, the UE 704 may measure or obtain an RSSI for estimating the CLI using CLI-RSSI measurement resources configured on frequency bands or subbands configured for uplink communications, downlink communications, and/or a guard band. Additionally or alternatively, the UE 704 may measure or obtain an RSRP for estimating the CLI using CLI SRS-RSRP measurement resources and/or SRS-RSRP measurement resources configured on frequency bands or subbands configured for uplink communications.

Subsequently, the UE 704 may send a CLI report to the network entity 702, where the CLI report includes the estimated CLI, measured RSSI, and/or measured RSRP. In some aspects, the network entity 702 may then adjust certain communication parameters (e.g., resource allocations for uplink and/or downlink communications, transmission power for the UE 704 and/or other UEs, transmission power for the network entity 702, etc.) in response to the CLI report transmitted by the UE 704 to mitigate and/or lessen the impacts of the CLI. In some aspects, the UE 704 may send CLI reports to the network entity 702 using L1 signaling, which may include signaling via the PHY layer. For example, the UE 704 may send the CLI report via UCI on a PUCCH and/or a PUSCH. In some aspects, the CLI-RSSI measurement resources, the CLI SRS-RSRP measurement resources, and/or SRS-RSRP measurement resources may also be sent via L1 signaling.

To enable the closed-loop feedback for CLI reporting, the network entity 702 and the UE 704 may exchange different types of information as part of a down selection package for CLI handling. For example, the different types of information may provide enhancements for CLI handling. In some aspects, the different types of information may be specific to the different types of CLI described previously.

For the inter-network entity CLI 712, the network entity 702 and the UE 704 may exchange information of a semi-static cell-specific SBFD time and frequency location configuration. That is, the network entity 702 may indicate (e.g., semi-statically, such as via RRC signaling) to the UE 704 a configuration of which subbands and time-domain resources are configured and/or allocated for downlink communications and for uplink communications for the SBFD communications, where the configuration is cell-specific. In some aspects, for the inter-network entity CLI 712, the network entity 702 and the UE 704 may also exchange information of a measurement resource configuration for the CLI measurement resources (e.g., the CLI-RSSI measurement resources, the CLI SRS-RSRP measurement resources, and/or SRS-RSRP measurement resources). For example, the the network entity 702 may indicate to the UE 704 a configuration for the CLI measurement resources, such as whether the CLI measurement resources include SSBs and/or periodic non-zero power (NZP) CSI-RSs. In some aspects, for the inter-network entity CLI 712, the network entity 702 and the UE 704 may also exchange information of a strongest downlink beam. For example, the network entity 702 and/or the UE 704 may indicate which downlink beam from the network entity 702 has a highest signal strength and/or other highest signal quality measurement (e.g., based on previous measurements, such as via CSI feedback).

In some aspects, for the inter-network entity CLI 712, the network entity 702 and the UE 704 may also exchange information of a CLI mitigation request. For example, the UE 704 may send a request to the network entity 702 to perform a CLI mitigation and/or CLI handling via the CLI feedback described previously, where the CLI feedback is performed based on exchange of the CLI mitigation request. In some aspects, the UE 704 may not send a ‘stop’ message to the network entity 702 for the CLI mitigation.

In some aspects, for the inter-network entity CLI 712, the network entity 702 and the UE 704 may also exchange information of uplink resource muting for PUSCH. For example, the network entity 702 may indicate an uplink resource muting pattern to the UE 704 (e.g., which uplink resources for the UE 704 to mute and/or on which uplink resources the UE 704 is to refrain from sending signaling) for the CLI measurements. In some aspects, the indication and/or determination of uplink resource muting for PUSCH may be based on a semi-static configuration (e.g., assuming a comb-2 type for both DFT-S-OFDM and CP-OFDM in each allocated PRB, where the UE 704 transmits on every second subcarrier, and up to two symbols in the time domain). Additionally, the network entity 702 and the UE 704 may exchange information on a PUSCH resource mapping (e.g., rate-matching around the muted resources). The UE 704 may also perform a UCI resource determination in symbols with muted resources, where the UCI resource determination does not have an impact on data and control multiplexing. In some aspects, the uplink resource muting may not apply for different uplink messages, such as a Msg A PUSCH and/or a Msg 3 PUSCH for random access channel (RACH) procedures. In some aspects, the uplink resource muting may apply for UEs in a connected state or mode (e.g., RRC_CONNECTED mode) with the network entity 702. In some aspects, the UE 704 may assume that the uplink resource muting pattern does not overlap with uplink DMRS and/or PT-RS in a same symbol. In some aspects, power boosting may be assumed for REs in the symbol with the uplink resource muting, and a PUSCH transmit power may be assumed to not change across symbols. In some aspects, the exchange of information of the uplink resource muting for PUSCH may be subject to UE capability (e.g., of the UE 704).

Additionally or alternatively, for the different types of UE-to-UE CLI (e.g., the intra-cell UE-to-UE CLI 714 and/or the inter-cell UE-to-UE CLI 716), a L1-based UE-to-UE CLI measurement and reporting based on the framework for CSI feedback may be used as described previously. For example, for the different types of UE-to-UE CLI, the network entity 702 and the UE 704 may exchange information of the CLI measurement resources (e.g., the CLI-RSSI measurement resources, the CLI SRS-RSRP measurement resources, and/or SRS-RSRP measurement resources). That is, the network entity 702 may indicate to the UE 704 whether the CLI measurement resources are periodic (e.g., semi-statically configured to occur according to a periodicity), semi-persistent (e.g., semi-statically configured to occur according to a periodicity and dynamically activated), or aperiodic (e.g., dynamically configured and activated). In some aspects, a configuration and/or determination of a ‘typeD’ quasi-colocation (QCL) assumptions (e.g., a spatial relationship between antenna ports used for communicating uplink signals and antenna ports for communicating downlink signals) for the CLI measurement resources may be used.

In some aspects, for the different types of UE-to-UE CLI, the network entity 702 and the UE 704 may exchange information of the CLI measurement reporting. For example, the network entity 702 may indicate for the UE 704 to send the CLI reports periodically, semi-persistently, or aperiodically. In some aspects, the network entity 702 may also indicate to the UE 704 of the contents to include in the CLI reports. For example, the network entity 702 may indicate for the UE 704 to include L1-SRS-RSRP measurements (e.g., measurements of the the CLI SRS-RSRP measurement resources and/or SRS-RSRP measurement resources), L1-CLI-RSSI measurements (e.g., measurements of the CLI-RSSI measurement resources), and/or indices of the CLI measurement resources. In some aspects, at least wideband reporting may be supported for the CLI reports. In some aspects, the UE 704 may perform a UCI bits generation for sending the CLI reports via L1 signaling. In some aspects, priority rules may be defined for multiple CSI reporting (e.g., whether the CLI reports have higher priority or lower priority over other types of CSI reports). In some aspects, L1 UE-to-UE CLI measurement and reporting may be based on a CSI processing unit, a CPU occupation rule, and a timeline for L1 beam reporting. In some aspects, a CLI measurement accuracy may be defined and used for the CLI reports.

To support the L1 CLI measurements and reporting, IEs for the different types of CLI measurement resource(s) may be defined. For example, for the CLI SRS-RSRP measurement resource(s) and/or SRS-RSRP measurement resource(s), an IE may be defined (e.g., an SRS-RSRP-MeasurementResourceSet IE) that indicates a set of SRS-RSRP measurement resource(s) (e.g., SRS-RSRP-MeasurementResource set) for L1 SRS-RSRP measurement to estimate the CLI. In some aspects, the IE may include a configuration of a slot offset between a first slot that includes a DCI that triggers a set of aperiodic SRS-RSRP measurement resources and a second slot in which the SRS-RSRP measurement resource set is measured.

Additionally or alternatively, for the CLI-RSSI measurement resource(s), an additional IE (e.g., CLI-RSSI-MeasurementResourceSet IE) may be defined that indicates a set of CLI-RSSI measurement resource(s) (e.g., CLI-RSSI-MeasurementResource set) for L1 CLI-RSSI measurement to estimate the CLI. In some aspects, the additional IE may include a configuration of a slot offset between a first slot that includes a DCI that triggers a set of aperiodic CLI-RSSI resources and a second slot in which the CLI-RSSI resource set is measured. In some aspects, the additional IE may include additional parameters for the set of CLI-RSSI measurement resource(s), such as an identifier (ID), a starting PRB index, a quantity of PRBs, a starting symbol within a slot, a quantity of symbols within a slot, a periodicity and slot offset, etc., for the set of CLI-RSSI measurement resource(s).

However, as described herein, the IEs defined for the different types of CLI measurement resource(s) may not include and/or indicate an exact frequency location, SCS, and/or other parameters for the CLI measurement resources for the UE 704 to estimate the CLI, measure the RSSI, and/or measure the RSRP. As such, the UE 704 may monitor for the CLI measurement resources across an entire frequency band or subband based on not knowing the exact frequency location for the CLI measurement resources, which may consume extraneous processing power at the UE. Additionally or alternatively, the UE 704 may improperly estimate the CLI, measure the RSSI, and/or measure the RSRP based on not knowing the exact frequency location, SCS, and/or the other parameters for the CLI measurement resources.

Aspects Related to CLI Handling based on Frequency Reference Point and SCS of CLI Measurement Resources

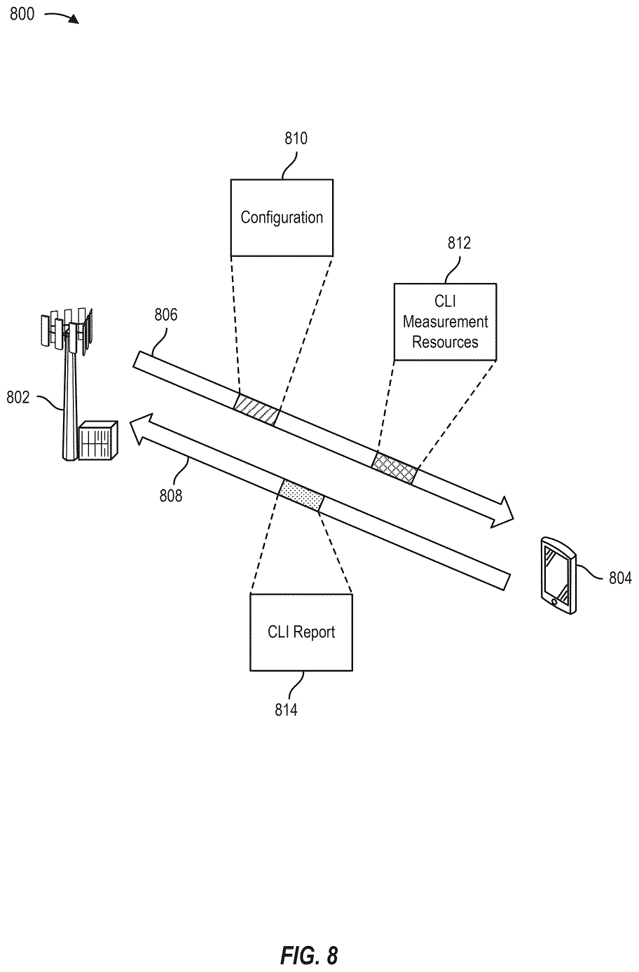

FIG. 8 depicts an example wireless communications network 800 that supports CLI handling based on a determination and/or configuration of a frequency reference point and SCS of CLI measurement resource(s) in accordance with aspects of the present disclosure. In some examples, the wireless communications network 800 may implement aspects of or may be implemented by aspects of FIGS. 1-7C. For example, the wireless communications network 800 may include a network entity 802 and a UE 804. In some aspects, the network entity 802 may be an example of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIG. 5, the network entity 602 depicted and described with respect to FIG. 6C, or the network entities 702 depicted and described with respect to FIGS. 7A-7C. Similarly, the UE 804 may be an example of the UE 104 depicted and described with respect to FIG. 1, the UE 304 depicted and described with respect to FIG. 3, the UE 504 depicted and described with respect to FIG. 5, the UEs 604 depicted and described with respect to FIG. 6C, or the UEs 704 depicted and described with respect to FIGS. 7A-7C.

Additionally, the wireless communications network 800 may be an example of wireless communications network 100 and may support communication between the network entity 802 and the UE 804. For example, the network entity 802 and the UE 804 may wirelessly communicate via a communication link 806 (e.g., a downlink communication link, one or more carriers, a communication link 120, etc.) and a communication link 808 (e.g., an uplink communication link, one or more carriers, a communication link 120, etc.).

In some aspects, the network entity 802 may support full-duplex communications (e.g., as depicted and described with respect to FIGS. 6A-6C). For example, the network entity 802 may simultaneously communicate in the downlink and in the uplink on a set of same time-domain resources. As described previously, the full-duplex communications may cause CLI at the network entity 802 (e.g., inter-network entity CLI) and/or at the UE 804 (e.g., intra-band UE-to-UE CLI and/or inter-band UE-to-UE CLI). Accordingly, to mitigate the CLI, the network entity 802 and the UE 804 may perform a closed-loop feedback for CLI reporting as described previously. As described herein, for the CLI measurement and reporting, a determination and/or configuration of a frequency reference point and SCS for L1 UE-to-UE CLI measurement resources (e.g., CLI SRS-RSRP and CLI-RSSI measurement resources) is provided.

That is, the UE 804 may determine the frequency reference point and SCS for the L1 UE-to-UE CLI measurement resources based on identifying (e.g., determining and/or obtaining) configuration or a determination rule that indicates the frequency reference point and SCS for the L1 UE-to-UE CLI measurement resources. For example, the network entity 802 may send a configuration to the UE 804 that indicates the frequency reference point and SCS for the L1 UE-to-UE CLI measurement resources (e.g., explicit indication of the frequency reference point and SCS) and/or indicates how the UE 804 is to determine the frequency reference point and SCS for the L1 UE-to-UE CLI measurement resources (e.g., implicit indication of the frequency reference point and SCS). Additionally or alternatively, the UE 804 may determine the frequency reference point and SCS for the L1 UE-to-UE CLI measurement resources according to the determination rule (e.g., a predefined rule that indicates the frequency reference point and SCS for the L1 UE-to-UE CLI measurement resources and/or how the UE 804 is to determine the frequency reference point and SCS for the L1 UE-to-UE CLI measurement resources).

In the example of FIG. 8, the network entity 802 may send a configuration 810 to the UE 804 (e.g., via the communication link 806). In some aspects, the configuration 810 may include a CSI report configuration (e.g., CSI-ReportConfig) that indicates for the UE 804 to perform the CLI measurement and reporting. Additionally or alternatively, the configuration 810 may include a DCI message that activates the CSI report configuration (e.g., for aperiodic CLI measurement and reporting). In some aspects, the configuration 810 may indicate an SCS and/or a frequency reference point associated with one or more L1 UE-to-UE CLI measurement resources. For example, the UE 804 may determine the SCS and/or the frequency reference point associated with the one or more L1 UE-to-UE CLI measurement resources based on information included in the configuration 810. Additionally or alternatively, the configuration 810 may include the SCS and/or the frequency reference point associated with the one or more L1 UE-to-UE CLI measurement resources. In some aspects, the network entity 802 may send the configuration 810 based on the UE 804 sending a CLI mitigation request to the network entity 802.

The UE 804 may obtain the configuration 810 via a first cell and/or via a first CC. Subsequently, in some aspects, the UE 804 may obtain one or more CLI measurement resources 812 via the first cell and/or via the first CC and may measure the one or more CLI measurement resources 812 via the first cell and/or via the first CC. That is, the UE 804 may measure the one or more CLI measurement resources 812 on a same serving cell via which the configuration 810 is obtained. In some aspects, the one or more CLI measurement resources 812 may include the one or more L1 UE-to-UE CLI measurement resources, such as CLI-RSSI measurement resources, CLI SRS-RSRP measurement resources, and/or SRS-RSRP measurement resources. For example, the one or more CLI measurement resources 812 may be sent via L1 signaling.

The one or more CLI measurement resources 812 may be defined with an IE (e.g., as described previously with respect to FIG. 7C). In some aspects, the network entity 802 may define the one or more CLI measurement resources 812 with respective IEs per downlink BWP (e.g., a set of contiguous RBs configured inside a channel bandwidth) of a plurality of downlink BWPs. That is, the network entity 802 may configure the one or more CLI measurement resources 812 per downlink BWP based on indicating the respective IEs per downlink BWP. In some aspects, parameters of the one or more CLI measurement resources 812 defined by the respective IEs may be the same or different per downlink BWP. Subsequently, the network entity 802 may send and the UE 804 may monitor for and measure the one or more CLI measurement resources 812 in an active downlink BWP when the CLI measuring and reporting is activated (e.g., after the configuration 810 is sent), where the one or more CLI measurement resources 812 are allocated in the active downlink BWP based on information included in the IE for that corresponding downlink BWP.

In some such aspects, the UE 804 may determine an SCS for the one or more CLI measurement resources 812 according to an SCS of the active downlink BWP or an active uplink BWP (e.g., the active downlink BWP and the active uplink BWP are the same for a TDD carrier), such that the SCS for the one or more CLI measurement resources 812 is based on the SCS of the active downlink BWP or the SCS of the active uplink BWP. That is, the UE may determine the SCS for the one or more CLI measurement resources 812 to be the same as a configured SCS for the active downlink BWP or a configured SCS for the active uplink BWP. Similarly, a frequency reference point to find a first RB for the one or more CLI measurement resources 812 may be based on a first or starting RB (e.g., PRB#0) of the active downlink BWP. That is, the IE that defines the one or more CLI measurement resources 812 per downlink BWP may include a starting PRB index and/or frequency offset value for the start of the one or more CLI measurement resources 812, and the starting PRB index and/or frequency offset value may be defined in relation to the frequency reference point.

Additionally or alternatively, in some aspects, the network entity 802 may define the one or more CLI measurement resources 812 with the IE per a reference downlink BWP. For example, the UE 804 may determine which downlink BWP of a plurality of downlink BWPs is the reference downlink BWP based on the IE being indicated for that downlink BWP, where the remaining downlink BWPs do not include an IE that defines the one or more CLI measurement resources 812. In some such aspects, the UE 804 may determine the SCS for the one or more CLI measurement resources 812 according to the SCS of the reference downlink BWP or the SCS of the active downlink BWP, such that the SCS of the one or more CLI measurement resources 812 is based on the SCS of the reference downlink BWP or the SCS of the active downlink BWP. That is, the UE may determine the SCS of the one or more CLI measurement resources 812 to be the same as the configured SCS for the reference downlink BWP or the configured SCS for the active downlink BWP.

In some aspects, the network entity 802 may configure the reference downlink BWP as the downlink BWP that has the largest SCS of the plurality of downlink BWPs. As an example, the plurality of downlink BWPs may include configured SCSs of 15 kHz or 30 kHz (e.g., SCSs may include configured values of 15 kHz, 30 kHz, 60 kHz, 120 kHz, or 240 kHz), and network entity 802 may configure the reference downlink BWP as a downlink BWP of the plurality of downlink BWPs that is configured with the 30 kHz SCS. That is, the reference downlink BWP may be the BWP with the largest SCS of the plurality of downlink BWPs. Additionally, when the one or more CLI measurement resources 812 are defined with the IE per the reference downlink BWP, the frequency reference point to find the first RB for the one or more CLI measurement resources 812 may be based on a first or starting RB (e.g., PRB#0) of the reference downlink BWP.

Additionally or alternatively, in some aspects, the network entity 802 may define the one or more CLI measurement resources 812 with the IE per cell under a second IE that includes configuration parameters for the cell (e.g., ServingCellConfig IE). For example, the second IE may include a dedicated parameter that indicates the IE for the one or more CLI measurement resources 812. Alternatively, the second IE may include a CSI measurement configuration parameter (e.g., csi-MeasConfig parameter) that indicates the IE for the one or more CLI measurement resources 812. In some such aspects, the SCS for the one or more CLI measurement resources 812 may be configured in the IE that defines the one or more CLI measurement resources 812 (e.g., the SCS for the one or more CLI measurement resources 812 is a configured SCS indicated by parameters in the IE). Alternatively, the SCS for the one or more CLI measurement resources 812 may be based on the SCS of the active downlink BWP. That is, the UE 804 may determine the SCS for the one or more CLI measurement resources 812 according to the SCS of the active downlink BWP (e.g., the SCS for the one or more CLI measurement resources 812 is the same as the configured SCS for the active downlink BWP).

When the one or more CLI measurement resources 812 are defined with the IE per cell under the second IE, the frequency reference point to find the first RB for the one or more CLI measurement resources 812 may be based on a PRB where the one or more CLI measurement resources 812 start in relation to a common resource block #0 (e.g., CRB #0) on a common resource block grid. For example, a common resource block grid may include one or more common resource blocks that are used to occupy an entire channel bandwidth and are numbered from ‘0’ (e.g., CRB #0) upwards (e.g., how many common resource blocks in the common resource block grid may be based on the SCS), and each common resource block may include a set of RBs. In some aspects, the PRB where the one or more CLI measurement resources 812 start may be in integer multiples of N (e.g., 0, N, 2N, etc.). Additionally, in some aspects, the measured RBs for the one or more CLI measurement resources 812 may be all located within the active downlink BWP.

In some aspects, rather than obtaining and measuring the one or more CLI measurement resources 812 via the first cell and/or via the first CC, the UE 804 may obtain and measure the one or more CLI measurement resources 812 via a second cell and/or via a second CC. That is, the UE 804 may measure the one or more CLI measurement resources 812 on a different CC than a CC that the configuration 810 is obtained. For example, the UE 804 may still obtain the configuration 810 via the first cell and/or via the first CC, but the configuration 810 may include a carrier parameter that indicates in which serving cell the one or more CLI measurement resources 812 are to be found. Accordingly, the carrier parameter may indicate the second cell and/or second CC for the UE 804 to monitor for and measure the one or more CLI measurement resources 812. In some aspects, if the carrier parameter is absent, the one or more CLI measurement resources 812 may be configured on the same serving cell that the configuration 810 is obtained.

Similar to the techniques described above where the configuration 810 and the one or more CLI measurement resources 812 are obtained on a same cell, the one or more CLI measurement resources 812 may be defined with an IE (e.g., as described previously with respect to FIG. 7C). For example, the network entity 802 may define the one or more CLI measurement resources 812 with respective IEs per downlink BWP of a plurality of downlink BWPs, but the plurality of BWPs may be configured on the second cell and/or second CC. Accordingly, the UE 804 may determine the SCS for the one or more CLI measurement resources 812 based on an SCS of the active downlink BWP or an SCS of the active uplink BWP (e.g., as described previously) of the cell and/or CC that the UE 804 measures the one or more CLI measurement resources 812 (e.g., the second cell and/or second CC). Similarly, the frequency reference point to find the first RB for the one or more CLI measurement resources 812 may be based on a first or starting RB (e.g., PRB#0) of the active downlink BWP of the cell and/or CC that the UE 804 measures the one or more CLI measurement resources 812 (e.g., the second cell and/or second CC).

Additionally or alternatively, the network entity 802 may define the one or more CLI measurement resources 812 with the IE per the reference downlink BWP, but the reference downlink BWP may be configured on the second cell and/or second CC. Accordingly, the UE may determine the SCS of the one or more CLI measurement resources 812 based on the SCS of the reference downlink BWP (e.g., as described previously) of the cell and/or CC that the UE 804 measures the one or more CLI measurement resources 812 (e.g., the second cell and/or second CC) or based on the SCS of the active downlink BWP (e.g., as described previously) of the cell and/or CC that the UE 804 measures the one or more CLI measurement resources 812 (e.g., the second cell and/or second CC). In some aspects, the network entity 802 may configure the reference downlink BWP as the downlink BWP that has the largest SCS of the plurality of downlink BWPs of the second cell and/or second CC. Additionally, when the one or more CLI measurement resources 812 are defined with the IE per the reference downlink BWP on the second cell and/or second CC, the frequency reference point to find the first RB for the one or more CLI measurement resources 812 may be based on a first or starting RB (e.g., PRB#0) of the reference downlink BWP of the cell and/or CC that the UE 804 measures the one or more CLI measurement resources 812 (e.g., the second cell and/or second CC).

Additionally or alternatively, the network entity 802 may define the one or more CLI measurement resources 812 with the IE per cell under the second IE that includes configuration parameters for the cell (e.g., ServingCellConfig 1E), but the second IE may be indicated for the second cell. Accordingly, the SCS for the one or more CLI measurement resources 812 may be configured in the IE that defines the one or more CLI measurement resources 812 (e.g., the SCS for the one or more CLI measurement resources 812 is a configured SCS indicated by parameters in the IE). Alternatively, the SCS for the one or more CLI measurement resources 812 may be based on the SCS of the active downlink BWP of the cell and/or CC that the UE 804 measures the one or more CLI measurement resources 812 (e.g., the second cell and/or second CC). That is, the UE 804 may determine the SCS for the one or more CLI measurement resources 812 according to the SCS of the active downlink BWP (e.g., as described previously) of the second cell and/or second CC. Additionally, when the one or more CLI measurement resources 812 are defined with the IE per cell under the second IE, the frequency reference point to find the first RB for the one or more CLI measurement resources 812 may be based on a PRB where the one or more CLI measurement resources 812 start in relation to a common resource block #0 (e.g., CRB #0) on a common resource block grid of the cell and/or CC that the UE 804 measures the one or more CLI measurement resources 812 (e.g., the second cell and/or second CC). In some aspects, the PRB where the one or more CLI measurement resources 812 start may be in multiples of N (e.g., 0, N, 2N, etc.). Additionally, in some aspects, the measured RBs for the one or more CLI measurement resources 812 may be all located within the active downlink BWP of the cell and/or CC that the UE 804 measures the one or more CLI measurement resources 812 (e.g., the second cell and/or second CC).

In some aspects, the UE 804 may determine the frequency reference point and SCS for the one or more CLI measurement resources 812 according to the different options described above based on the determination rule. For example, the UE 804 may be programmed and/or preconfigured with the determination rule, where the determination rule includes one or more predefined rules that indicate the frequency reference point and SCS for the one or more CLI measurement resources 812 and/or how the UE 804 is to determine the frequency reference point and SCS for the one or more CLI measurement resources 812. That is, the determination rule may indicate that the frequency reference point for the one or more CLI measurement resources 812 is to be determined by the UE 804 according to the different options described above (e.g., based on the first or starting RB of an active downlink BWP or of a reference downlink BWP or a first or starting common resource block). Similarly, the determination rule may indicate that the SCS for the one or more CLI measurement resources 812 is to be determined by the UE 804 according to the different options described above (e.g., based on the SCS of an active downlink BWP, an active uplink BWP, or a reference downlink BWP).

Subsequently, after the UE 804 obtains and measures the one or more CLI measurement resources 812 based on the identified (e.g., configured and/or determined) configuration or determination rule of the SCS and frequency reference point according to the different options described above, the UE 804 may send a CLI report 814 to the network entity 802 (e.g., via the communication link 808). In some aspects, the UE 804 may send the CLI report 814 via a same cell and/or same CC that the UE 804 obtains the configuration 810. For example, based on obtaining the configuration 810 via the first cell and/or the first CC, the UE 804 may send the CLI report 814 also via the first cell and/or the first CC. In some aspects, the CLI report 814 may include the measurements of the one or more CLI measurement resources 812 (e.g., CLI SRS-RSRP measurements, CLI-RSSI measurements, etc.). Additionally, in some aspects, the UE 804 may send the CLI report 814 to the network entity 802 using L1 signaling, such as via UCI on a PUCCH and/or a PUSCH. Accordingly, the network entity 802 may adjust certain communication parameters (e.g., resource allocations for uplink and/or downlink communications, transmission power for the UE 804 and/or other UEs, transmission power for the network entity 802, etc.) in response to the CLI report 814 to mitigate and/or lessen the impacts of the CLI.

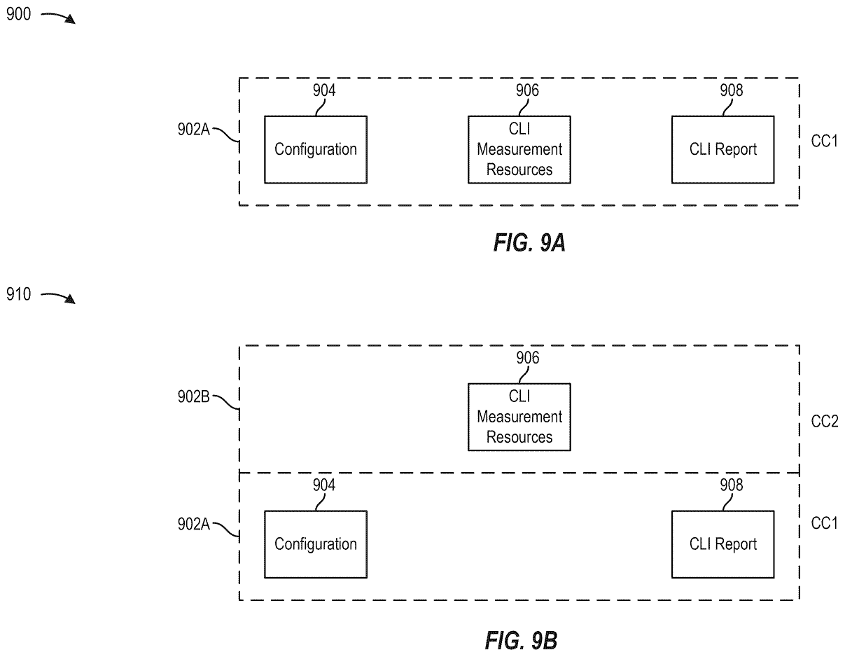

FIGS. 9A and 9B depict example configurations for reporting CLI feedback in accordance with aspects of the present disclosure. For example, FIG. 9A depicts a first configuration 900 for reporting CLI feedback, and FIG. 9B depicts a second configuration 910 for reporting CLI feedback. In some examples, the first configuration 900 and the second configuration 910 may implement aspects of or may be implemented by aspects of FIGS. 1-8. For example, a UE may use the first configuration 900 or the second configuration 910 to report CLI feedback based on a determination and/or configuration of an SCS and a frequency reference point for CLI measurement resources as described with respect to FIG. 8.

In the example of FIG. 9A, the UE may measure the CLI measurement resources on a same serving cell and/or same CC that the UE obtains a configuration 904 for CLI measurement and reporting (e.g., the configuration 810 depicted and described with respect to FIG. 8). For example, the UE may obtain the configuration 904 via a first CC 902A. Accordingly, the UE may then obtain and measure one or more CLI measurement resources 906 (e.g., the one or more CLI measurement resources 812 depicted and described with respect to FIG. 8) via the first CC 902A as well. In some aspects, the SCS and the frequency reference point for the one or more CLI measurement resources 906 may be determined and/or configured as described with respect to FIG. 8. Subsequently, the UE may then send a CLI report 908 via the first CC 902A based on obtaining the configuration 904 via the first CC 902A.

Alternatively, in the example of FIG. 9B, the UE may measure the CLI measurement resources on a different serving cell and/or same CC that the UE obtains the configuration 904 for CLI measurement and reporting. For example, the UE may obtain the configuration 904 via the first CC 902A. However, the configuration 904 may include a “carrier” parameter to indicate which CC the UE is to monitor for, obtain, and measure the one or more CLI measurement resources 906 (e.g., a “carrier” parameter is not included in an IE that defines the one or more CLI measurement resources 906). For example, the “carrier” parameter may indicates in which serving cell the one or more CLI measurement resources 906 are to be found. If the “carrier” parameter or field is absent in the configuration 904, the one or more CLI measurement resources 906 may be configured and sent on the same serving cell as the configuration 904 is obtained.

In the example of FIG. 9B, the “carrier” parameter in the configuration 904 may indicate that the one or more CLI measurement resources 906 are to be found on a second CC 902B (e.g., served via a second cell). Accordingly, the UE may then obtain and measure the one or more CLI measurement resources 906 via the second CC 902B. In some aspects, the SCS and the frequency reference point for the one or more CLI measurement resources 906 may be determined and/or configured as described with respect to FIG. 8 based on the cell and/or CC that the UE measures the one or more CLI measurement resources 906 (e.g., the second cell and/or the second CC 902B). Subsequently, the UE may then send the CLI report 908 via the first CC 902A based on obtaining the configuration 904 via the first CC 902A.

Example Signaling for Determination and/or Configuration of a Frequency Reference Point and SCS of CLI Measurement Resource(s)

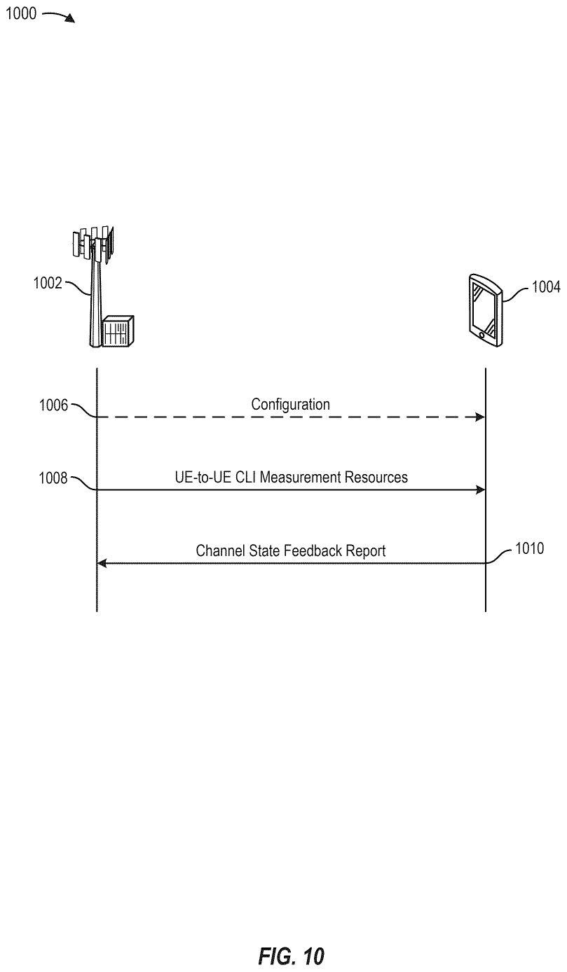

FIG. 10 depicts a process flow 1000 for communications in a network between a network entity 1002 and a UE 1004. In some aspects, the network entity 1002 may be an example of the BS 102 depicted and described with respect to FIG. 1, the first network entity 300 or the second network entity 302 depicted and described with respect to FIG. 3, a disaggregated base station depicted and described with respect to FIG. 2, or the network entity 802 depicted and described with respect to FIG. 8. Similarly, the UE 1004 may be an example of UE 104 depicted and described with respect to FIG. 1, the UE 304 depicted and described with respect to FIG. 3, or the UE 804 depicted and described with respect to FIG. 8. However, in other aspects, UE 1004 may be another type of wireless communications device and network entity 1002 may be another type of network entity or network node, such as those described herein. Note that any operations or signaling illustrated with dashed lines may indicate that that operation or signaling is an optional or alternative example.

As described herein, the UE 1004 identifies a configuration or a determination rule that indicates an SCS and a frequency reference point associated with one or more L1 UE-to-UE CLI measurement resources. For example, at 1006, the network entity 1002 may send and the UE 1004 may obtain the configuration (e.g., the configuration 810 depicted and described with respect to FIG. 8). Additionally or alternatively, the UE 1004 may determine the configuration according to the determination rule (e.g., specified rules for determining the frequency reference point and SCS of the one or more L1 UE-to-UE CLI measurement resources). In some aspects, the one or more UE-to-UE CLI measurement resources may include L1 UE-to-UE CLI SRS-RSRP measurement resources or L1 UE-to-UE CLI-RSSI measurement resources. In some aspects, the configuration may include a report configuration for a channel state feedback report (e.g., a CLI report and/or a CSI report that includes CLI feedback). In some aspects, the network entity 1002 may send and the UE 1004 may obtain the report configuration for the channel state feedback report via a first cell.

At 1008, the network entity 1002 sends and the UE 1004 obtains the one or more L1 UE-to-UE CLI measurement resources (e.g., the one or more CLI measurement resources 812 depicted and described with respect to FIG. 8). For example, the network entity 1002 may send and the UE 1004 may obtain the one or more L1 UE-to-UE CLI measurement resources on subbands configured for downlink communications and/or for guard bands. Additionally or alternatively, an additional UE may send and the UE 1004 may obtain the one or more L1 UE-to-UE CLI measurement resources. For example, the additional UE may send and the UE 1004 may obtain the one or more L1 UE-to-UE CLI measurement resources on subbands configured for uplink communications.

In some aspects, the UE 1004 may obtain the one or more L1 UE-to-UE CLI measurement resources via the first cell. For example, the network entity 1002 may send and the UE 1004 may obtain an IE for a downlink BWP of a plurality of downlink BWPs configured on the first cell. In some aspects, the IE may include one or more parameters of at least one L1 UE-to-UE CLI measurement resource of the one or more L1 UE-to-UE CLI measurement resources (e.g., the IE that defines the one or more CLI measurement resources 812 as described with respect to FIG. 8), and the at least one L1 UE-to-UE CLI measurement resource may have a frequency allocation within the downlink BWP (e.g., the at least one L1 UE-to-UE CLI measurement resource is sent within the downlink BWP). Accordingly, the frequency reference point associated with the one or more L1 UE-to-UE CLI measurement resources may be based on a first PRB (PRB#0) of an active downlink BWP of the plurality of downlink BWPs, and the SCS associated with the one or more L1 UE-to-UE CLI measurement resources may be based on an SCS of the active downlink BWP or an SCS of an active uplink BWP on the first cell.

Additionally or alternatively, the network entity 1002 may send and the UE 1004 may obtain an IE for a reference downlink BWP of the plurality of downlink BWPs configured on the first cell. In some aspects, the IE may include one or more parameters of at least one L1 UE-to-UE CLI measurement resource of the one or more L1 UE-to-UE CLI measurement resources (e.g., the IE that defines the one or more CLI measurement resources 812 as described with respect to FIG. 8). Accordingly, the frequency reference point associated with the one or more L1 UE-to-UE CLI measurement resources may be based on a first PRB (PRB#0) of the reference downlink BWP, and the SCS associated with the one or more L1 UE-to-UE CLI measurement resources may be based on one or more of: an SCS of the reference downlink BWP, or an SCS of the active downlink BWP on the first cell. In some aspects, the reference downlink BWP may include a largest SCS of one or more SCSs configured across the plurality of downlink BWPs.

Additionally or alternatively, the network entity 1002 may send and the UE 1004 may obtain a first IE for the first cell. In some aspects, the first IE may include one or more parameters of the one or more L1 UE-to-UE CLI measurement resources (e.g., the IE that defines the one or more CLI measurement resources 812 as described with respect to FIG. 8). Additionally, the network entity 1002 may send and the UE 1004 may obtain one or more second IEs that includes the first IE. For example, the one or more second IEs may be associated with one or more cells, respectively, where the one or more cells include at least the first cell, and the one or more second IEs also include one or more of: a dedicated parameter indicating the one or more L1 UE-to-UE CLI measurement resources, or a CSI measurement configuration parameter indicating the one or more L1 UE-to-UE CLI measurement resources. Accordingly, the frequency reference point associated with the one or more L1 UE-to-UE CLI measurement resources may be based on a starting PRB of the one or more L1 UE-to-UE CLI measurement resources in relation to a first common resource block of a common resource block grid configured for the first cell, and the SCS associated with the one or more L1 UE-to-UE CLI measurement resources is based on one or more of: a configured SCS for the one or more L1 UE-to-UE CLI measurement resources indicated via the one or more parameters of the first IE, or a determined SCS of the active downlink BWP on the first cell. In some aspects, the starting PRB may be based on a multiple of a number of RBs. In some aspects, the network entity 1002 may send and the UE 1004 may obtain the one or more L1 UE-to-UE CLI measurement resources in an active downlink BWP.

Additionally or alternatively, the UE 1004 may obtain the one or more L1 UE-to-UE CLI measurement resources via a second cell. For example, the configuration communicated at 1006 may include the report configuration, where the report configuration includes a carrier indication of the second cell, and the UE 1004 may obtain the one or more L1 UE-to-UE CLI measurement resources via the second cell based on the carrier indication.

In some aspects, the network entity 1002 may send and the UE 1004 may obtain an IE for a downlink BWP of a plurality of downlink BWPs configured on the second cell. In some aspects, the IE may include one or more parameters of at least one L1 UE-to-UE CLI measurement resource of the one or more L1 UE-to-UE CLI measurement resources (e.g., the IE that defines the one or more CLI measurement resources 812 as described with respect to FIG. 8), and the at least one L1 UE-to-UE CLI measurement resource may have a frequency allocation within the downlink BWP on the second cell (e.g., the at least one L1 UE-to-UE CLI measurement resource is sent within the downlink BWP on the second cell). Accordingly, the frequency reference point associated with the one or more L1 UE-to-UE CLI measurement resources may be based on a first PRB (PRB#0) of an active downlink BWP of the plurality of downlink BWPs on the second cell, and the SCS associated with the one or more L1 UE-to-UE CLI measurement resources may be based on an SCS of the active downlink BWP or an SCS of an active uplink BWP on the second cell.

Additionally or alternatively, the network entity 1002 may send and the UE 1004 may obtain an IE for a reference downlink BWP of the plurality of downlink BWPs configured on the second cell. In some aspects, the IE may include one or more parameters of at least one L1 UE-to-UE CLI measurement resource of the one or more L1 UE-to-UE CLI measurement resources (e.g., the IE that defines the one or more CLI measurement resources 812 as described with respect to FIG. 8). Accordingly, the frequency reference point associated with the one or more L1 UE-to-UE CLI measurement resources may be based on a first PRB (PRB#0) of the reference downlink BWP on the second cell, and the SCS associated with the one or more L1 UE-to-UE CLI measurement resources may be based on one or more of: an SCS of the reference downlink BWP on the second cell, or an SCS of the active downlink BWP on the second cell. In some aspects, the reference downlink BWP may include a largest SCS of one or more SCSs configured across the plurality of downlink BWPs on the second cell.

Additionally or alternatively, the network entity 1002 may send and the UE 1004 may obtain a first IE for the second cell. In some aspects, the first IE may include one or more parameters of the one or more L1 UE-to-UE CLI measurement resources (e.g., the IE that defines the one or more CLI measurement resources 812 as described with respect to FIG. 8). Additionally, the network entity 1002 may send and the UE 1004 may obtain one or more second IEs that includes the first IE For example, the one or more second IEs may be associated with one or more cells, respectively, where the one or more cells include at least the second cell, and the one or more second IEs also include one or more of: a dedicated parameter indicating the one or more L1 UE-to-UE CLI measurement resources on the second cell, or a CSI measurement configuration parameter indicating the one or more L1 UE-to-UE CLI measurement resources on the second cell. Accordingly, the frequency reference point associated with the one or more L1 UE-to-UE CLI measurement resources may be based on a starting PRB of the one or more L1 UE-to-UE CLI measurement resources in relation to a first common resource block of a common resource block grid configured for the second cell, and the SCS associated with the one or more L1 UE-to-UE CLI measurement resources is based on one or more of: a configured SCS for the one or more L1 UE-to-UE CLI measurement resources indicated via the one or more parameters of the first IE, or a determined SCS of the active downlink BWP on the second cell. In some aspects, the starting PRB may be based on a multiple of a number of RBs. In some aspects, the network entity 1002 may send and the UE 1004 may obtain the one or more L1 UE-to-UE CLI measurement resources in an active downlink BWP on the second cell.

At 1010, the UE 1004 sends and the network entity 1002 obtains the channel state feedback report for CLI measurement. For example, the channel state feedback report may include a CLI report (e.g., the CLI report 814 depicted and described with respect to FIG. 8). In some aspects, the channel state feedback report may include one or more measurements of the one or more L1 UE-to-UE CLI measurement resources based on the SCS and the frequency reference point.

Note that the process flow illustrated in FIG. 10 is an example of CLI handling and/or CLI mitigation, and aspects of the present disclosure may be applied to CLI handling and/or CLI mitigation based on a determination and/or configuration of a frequency reference point and SCS for CLI measurement resource(s). Note that the process flow illustrated in FIG. 10 is described herein to facilitate an understanding of a determination and/or configuration of a frequency reference point and SCS for CLI measurement resource(s), and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Operations of a User Equipment

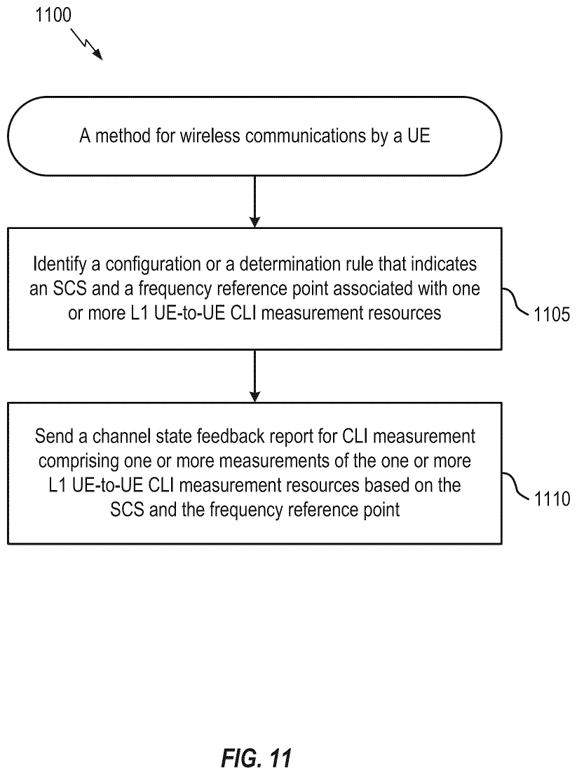

FIG. 11 shows a method 1100 for wireless communications by an apparatus, such as UE 104 of FIG. 1 or UE 304 of FIG. 3.

Method 1100 begins at block 1105 with identifying a configuration (e.g., the configuration 810 depicted and described with respect to FIG. 8) or a determination rule (e.g., specified rules programmed or preconfigured in the apparatus as described previously with respect to FIG. 8) that indicates a SCS and a frequency reference point associated with one or more L1 UE-to-UE CLI measurement resources (e.g., the one or more CLI measurement resources 812 depicted and described with respect to FIG. 8).

Method 1100 then proceeds to block 1110 with sending a channel state feedback report for CLI measurement comprising one or more measurements of the one or more L1 UE-to-UE CLI measurement resources (e.g., the CLI report 814 depicted and described with respect to FIG. 8) based on the SCS and the frequency reference point.

In some aspects, method 1100 further includes obtaining a report configuration for the channel state feedback report via a first cell.

In some aspects, method 1100 further includes obtaining the one or more L1 UE-to-UE CLI measurement resources via the first cell.

In some aspects, block 1105 includes obtaining an information element for a downlink BWP of a plurality of downlink BWPs configured on the first cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first PRB (PRB#0) of an active downlink BWP of the plurality of downlink BWPs, and the SCS associated with the one or more L1 UE-to-UE CLI measurement resources is based on an SCS of the active downlink BWP or an SCS of an active uplink BWP on the first cell.

In some aspects, block 1105 includes obtaining an information element for a reference downlink BWP of a plurality of downlink BWPs configured on the first cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first PRB (PRB#0) of the reference downlink BWP.

In some aspects, the SCS associated with the one or more L1 UE-to-UE CLI measurement resources is based on one or more of: an SCS of the reference downlink BWP, or an SCS of an active downlink BWP on the first cell.

In some aspects, the reference downlink BWP comprises a largest SCS of one or more SCSs configured across the plurality of downlink BWPs.

In some aspects, block 1105 includes obtaining a first information element for the first cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the first cell.

In some aspects, the SCS associated with the one or more L1 UE-to-UE CLI measurement resources is based on one or more of: a configured SCS for the one or more L1 UE-to-UE CLI measurement resources indicated via the one or more parameters, or a determined SCS of an active downlink BWP on the first cell.

In some aspects, method 1100 further includes obtaining one or more second information elements comprising the first information element, wherein: the one or more second information elements are associated with one or more cells, respectively, the one or more cells comprise the first cell, and the one or more second information elements comprise one or more of: a dedicated parameter indicating the one or more L1 UE-to-UE CLI measurement resources, or a channel state information measurement configuration parameter indicating the one or more L1 UE-to-UE CLI measurement resources.

In some aspects, the starting physical resource block is based on a multiple of a number of RBs.

In some aspects, method 1100 further includes obtaining the one or more L1 UE-to-UE CLI measurement resources of measured RBs in an active downlink BWP.

In some aspects, method 1100 further includes obtaining a report configuration for the channel state feedback report via a first cell, wherein the report configuration comprises a carrier indication of a second cell.

In some aspects, method 1100 further includes obtaining the one or more L1 UE-to-UE CLI measurement resources via the second cell.

In some aspects, block 1105 includes obtaining an information element for a downlink BWP of a plurality of downlink BWPs configured on the second cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first PRB (PRB#0) of an active downlink BWP of the plurality of downlink BWPs of the second cell, and the SCS associated with the one or more L1 UE-to-UE CLI measurement resources is based on an SCS of the active downlink BWP or an SCS of an active uplink BWP on the second cell.

In some aspects, block 1105 includes obtaining an information element for a reference downlink BWP of a plurality of downlink BWPs configured on the second cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first PRB (PRB#0) of the reference downlink BWP of the second cell.

In some aspects, the SCS associated with the one or more L1 UE-to-UE CLI measurement resources is based on one or more of: an SCS of the reference downlink BWP of the second cell, or an SCS of an active downlink BWP on the second cell.

In some aspects, the reference downlink BWP comprises a largest SCS of one or more SCSs configured across the plurality of downlink BWPs of the second cell.

In some aspects, block 1105 includes obtaining a first information element for the second cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the second cell.

In some aspects, the SCS associated with the one or more L1 UE-to-UE CLI measurement resources is based on one or more of: a configured SCS for the one or more L1 UE-to-UE CLI measurement resources indicated via the one or more parameters, or a determined SCS of an active downlink BWP on the second cell.

In some aspects, method 1100 further includes obtaining one or more second information elements comprising the first information element, wherein: the one or more second information elements are associated with one or more cells, respectively, the one or more cells comprise the second cell, and the one or more second information elements comprise one or more of: a dedicated parameter indicating the one or more L1 UE-to-UE CLI measurement resources, or a channel state information measurement configuration parameter indicating the one or more L1 UE-to-UE CLI measurement resources.

In some aspects, the starting physical resource block is based on a multiple of a number of RBs.

In some aspects, method 1100 further includes obtaining the one or more L1 UE-to-UE CLI measurement resources of measured RBs in an active downlink BWP on the second cell.

In some aspects, the one or more L1 UE-to-UE CLI measurement resources comprise one or more of: L1 UE-to-UE CLI SRS-RSRP measurement resources, or L1 UE-to-UE CLI-RSSI measurement resources.

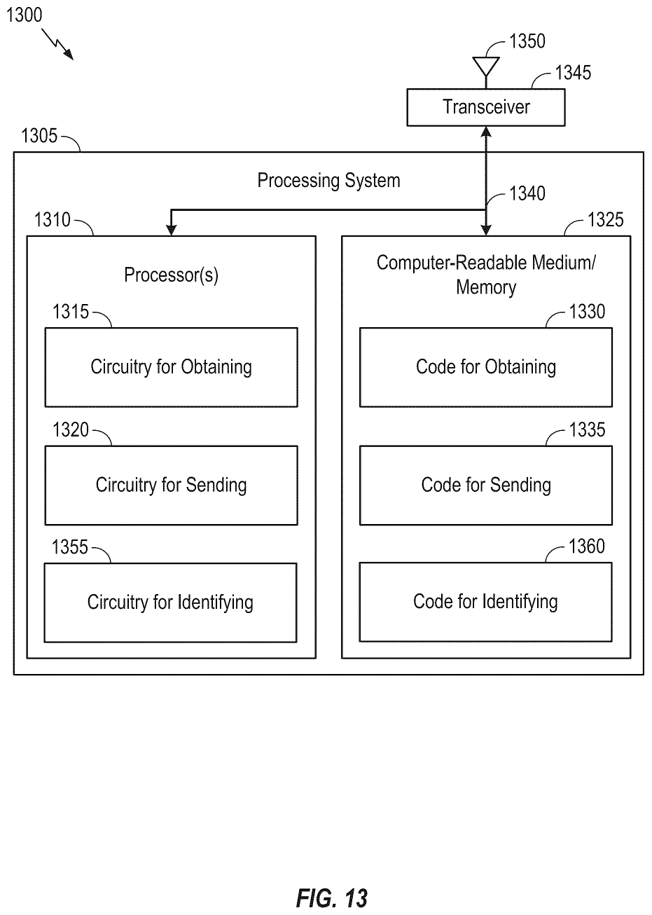

In some aspect, method 1100, or any aspect related to it, may be performed by an apparatus, such as communications device 1300 of FIG. 13, which includes various components operable, configured, or adapted to perform the method 1100.

Communications device 1300 is described below in further detail.

Note that FIG. 11 is just one example of a method, and other methods including fewer, additional, or alternative operations are possible consistent with this disclosure.

In certain aspects, method 1100 may be performed by the apparatus to realize one or more technical effects or solutions to the aforementioned technical problem(s). For example, based on method 1100, the techniques for determining and/or obtaining a configuration of a frequency reference point and an SCS for CLI measurement resource(s) may reduce power consumption and enable accurate CLI estimations. That is, the apparatus may determine and/or obtain a configuration of the frequency reference point for the CLI measurement resource(s), thereby enabling the apparatus to accurately identify where the CLI measurement resource(s) are located in frequency. Accordingly, the apparatus may reduce power consumption by accurately identifying the frequency location of the CLI measurement resource(s) rather than having to blindly monitor for the CLI measurement resource(s) across a wider frequency band. Additionally, the apparatus may determine and/or obtain a configuration of the SCS for the CLI measurement resource(s) to enable the apparatus to determine how the CLI measurement resource(s) are spaced or allocated in the frequency domain. Accordingly, the apparatus may accurately estimate and report the CLI to a network entity based on the determined or configured SCS for the CLI measurement resource(s), which may enable the network entity to successfully mitigate and/or lessen the effects of the accurately estimated CLI.

### Example Operations of a Network Entity

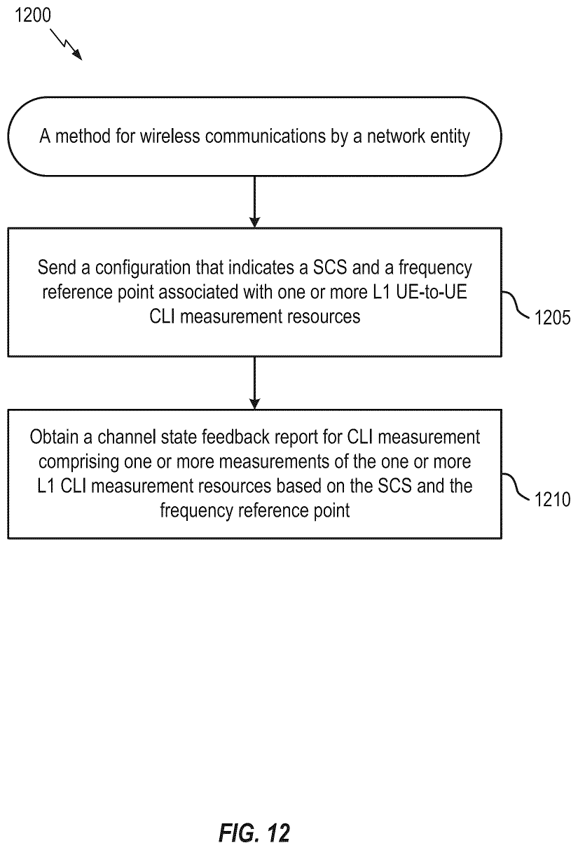

FIG. 12 shows a method 1200 for wireless communications by an apparatus, such as BS 102 of FIG. 1, a first network entity 300 or second network entity 302 of FIG. 3, or a disaggregated base station as discussed with respect to FIG. 2.

Method 1200 begins at block 1205 with sending a configuration (e.g., the configuration 810 depicted and described with respect to FIG. 8) that indicates a SCS and a frequency reference point associated with one or more L1 UE-to-UE CLI measurement resources (e.g., the one or more CLI measurement resources 812 depicted and described with respect to FIG. 8).

Method 1200 then proceeds to block 1210 with obtaining a channel state feedback report for CLI measurement comprising one or more measurements of the one or more L1 UE-to-UE CLI measurement resources (e.g., the CLI report 814 depicted and described with respect to FIG. 8) based on the SCS and the frequency reference point.

In certain aspects, method 1200 further includes sending a report configuration for the channel state feedback report via a first cell.

In certain aspects, method 1200 further includes sending the one or more L1 UE-to-UE CLI measurement resources via the first cell.

In some aspects, block 1205 includes sending an information element for a downlink BWP of a plurality of downlink BWPs configured on the first cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first PRB (PRB#0) of an active downlink BWP of the plurality of downlink BWPs, and the SCS associated with the one or more L1 UE-to-UE CLI measurement resources is based on an SCS of the active downlink BWP or an SCS of an active uplink BWP on the first cell.

In some aspects, block 1205 includes sending an information element for a reference downlink BWP of a plurality of downlink BWPs configured on the first cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first PRB (PRB#0) of the reference downlink BWP.

In some aspects, the SCS associated with the one or more L1 UE-to-UE CLI measurement resources is based on one or more of: an SCS of the reference downlink BWP, or an SCS of an active downlink BWP on the first cell.

In some aspects, the reference downlink BWP comprises a largest SCS of one or more SCSs configured across the plurality of downlink BWPs.

In some aspects, block 1205 includes sending a first information element for the first cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the first cell.

In some aspects, the SCS associated with the one or more L1 UE-to-UE CLI measurement resources is based on one or more of: a configured SCS for the one or more L1 UE-to-UE CLI measurement resources indicated via the one or more parameters, or an SCS of an active downlink BWP on the first cell.

In certain aspects, method 1200 further includes sending one or more second information elements comprising the first information element, wherein: the one or more second information elements are associated with one or more cells, respectively, the one or more cells comprise the first cell, and the one or more second information elements comprise one or more of: a dedicated parameter indicating the one or more L1 UE-to-UE CLI measurement resources, or a channel state information measurement configuration parameter indicating the one or more L1 UE-to-UE CLI measurement resources.

In some aspects, the starting physical resource block is based on a multiple of a number of RBs.

In certain aspects, method 1200 further includes sending the one or more L1 UE-to-UE CLI measurement resources of measured RBs in an active downlink BWP.

In certain aspects, method 1200 further includes sending a report configuration for the channel state feedback report via a first cell, wherein the report configuration comprises a carrier indication of a second cell.

In certain aspects, method 1200 further includes sending the one or more L1 UE-to-UE CLI measurement resources via the second cell.

In some aspects, block 1205 includes sending an information element for a downlink BWP of a plurality of downlink BWPs configured on the second cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first PRB (PRB#0) of an active downlink BWP of the plurality of downlink BWPs of the second cell, and the SCS associated with the one or more L1 UE-to-UE CLI measurement resources is based on an SCS of the active downlink BWP or an SCS of an active uplink BWP on the second cell.

In some aspects, block 1205 includes sending an information element for a reference downlink BWP of a plurality of downlink BWPs configured on the second cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first PRB (PRB#0) of the reference downlink BWP of the second cell.

In some aspects, the SCS associated with the one or more L1 UE-to-UE CLI measurement resources is based on one or more of: an SCS of the reference downlink BWP of the second cell, or an SCS of an active downlink BWP on the second cell.

In some aspects, the reference downlink BWP comprises a largest SCS of one or more SCSs configured across the plurality of downlink BWPs of the second cell.

In some aspects, block 1205 includes sending a first information element for the second cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the second cell.

In some aspects, the SCS associated with the one or more L1 UE-to-UE CLI measurement resources is based on one or more of: a configured SCS for the one or more L1 UE-to-UE CLI measurement resources indicated via the one or more parameters, or an SCS of an active downlink BWP on the second cell.

In certain aspects, method 1200 further includes sending one or more second information elements comprising the first information element, wherein: the one or more second information elements are associated with one or more cells, respectively, the one or more cells comprise the second cell, and the one or more second information elements comprise one or more of: a dedicated parameter indicating the one or more L1 UE-to-UE CLI measurement resources, or a channel state information measurement configuration parameter indicating the one or more L1 UE-to-UE CLI measurement resources.

In some aspects, the starting physical resource block is based on a multiple of a number of RBs.

In certain aspects, method 1200 further includes sending the one or more L1 UE-to-UE CLI measurement resources of measured RBs in an active downlink BWP on the second cell.

In some aspects, the one or more L1 UE-to-UE CLI measurement resources comprise one or more of: L1 UE-to-UE CLI SRS-RSRP measurement resources, or L1 UE-to-UE CLI-RSSI measurement resources.

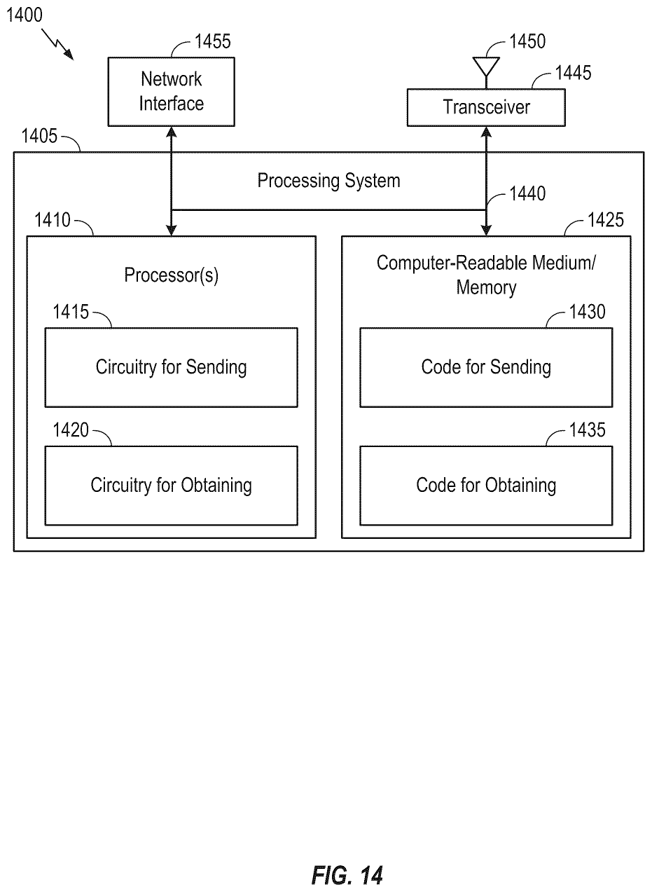

In some aspect, method 1200, or any aspect related to it, may be performed by an apparatus, such as communications device 1400 of FIG. 14, which includes various components operable, configured, or adapted to perform the method 1200.

Communications device 1400 is described below in further detail.

Note that FIG. 12 is just one example of a method, and other methods including fewer, additional, or alternative operations are possible consistent with this disclosure.

In certain aspects, method 1200 may be performed by the apparatus to realize one or more technical effects or solutions to the aforementioned technical problem(s). For example, based on method 1200, the techniques for determining and/or obtaining a configuration of a frequency reference point and an SCS for CLI measurement resource(s) may enable accurate CLI estimations. That is, the apparatus may implicitly or explicitly indicate the frequency reference point and the SCS for the CLI measurement resource(s) to a UE, which may enable the UE to accurately identify the frequency location of the CLI measurement resource(s) and determine how the CLI measurement resource(s) are spaced or allocated in the frequency domain. Accordingly, the UE may accurately estimate and report the CLI to the apparatus based on the implicitly or explicitly indicated frequency reference point and SCS for the CLI measurement resource(s), which may enable the apparatus to successfully mitigate and/or lessen the effects of the accurately estimated CLI.

### Example Communications Devices

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for obtaining 1330, code for sending 1335, and code for identifying 1360. Processing of the code 1330, 1335, and 1360 may enable and cause the communications device 1300 to perform the method 1100 described with respect to FIG. 11, or any aspect related to it. For example in some aspects, code for identifying 1360 includes code for identifying a configuration or a determination rule that indicates a SCS and a frequency reference point associated with one or more L1 UE-to-UE CLI measurement resources. In some aspects, code for sending 1335 includes code for sending a channel state feedback report for CLI measurement comprising one or more measurements of the one or more L1 UE-to-UE CLI measurement resources based on the SCS and the frequency reference point.

The one or more processors 1310 include circuitry configured to implement (e.g., execute) the code stored in the computer-readable medium/memory 1325, including circuitry for obtaining 1315, circuitry for sending 1320, and circuitry for identifying 1355. Processing with circuitry 1315, 1320, and 1355 may enable and cause the communications device 1300 to perform the method 1100 described with respect to FIG. 11, or any aspect related to it. For example in some aspects, circuitry for identifying 1355 includes circuitry for identifying a configuration or a determination rule that indicates a SCS and a frequency reference point associated with one or more L1 UE-to-UE CLI measurement resources. In some aspects, circuitry for sending 1320 includes circuitry for sending a channel state feedback report for CLI measurement comprising one or more measurements of the one or more L1 UE-to-UE CLI measurement resources based on the SCS and the frequency reference point.

More generally, means for communicating, transmitting, sending or outputting for transmission may include the one or more transceivers 324, one or more antenna 322 and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13. Means for communicating, receiving, identifying or obtaining may include the one or more transceivers 324, one or more antennas 322, and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code 1430 and 1435, that when executed by the one or more processors 1410, cause the one or more processors 1410 to perform the method 1200 described with respect to FIG. 12, or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for sending 1430 and code for obtaining 1435. Processing of the code 1430 and 1435 may enable and cause the communications device 1400 to perform the method 1200 described with respect to FIG. 12, or any aspect related to it. For example, in some aspects, code for sending 1430 includes code for sending a configuration that indicates a SCS and a frequency reference point associated with one or more L1 UE-to-UE CLI measurement resources. In some aspects, code for obtaining 1435 includes code for obtaining a channel state feedback report for CLI measurement comprising one or more measurements of the one or more L1 UE-to-UE CLI measurement resources based on the SCS and the frequency reference point.

The one or more processors 1410 include circuitry configured to implement (e.g., execute) the code stored in the computer-readable medium/memory 1425, including circuitry for sending 1415 and circuitry for obtaining 1420. Processing with circuitry 1415 and 1420 may enable and cause the communications device 1400 to perform the method 1200 described with respect to FIG. 12, or any aspect related to it. For example, in some aspects, circuitry for sending 1415 includes co circuitry de for sending a configuration that indicates a SCS and a frequency reference point associated with one or more L1 UE-to-UE CLI measurement resources. In some aspects, circuitry for obtaining 1420 includes circuitry for obtaining a channel state feedback report for CLI measurement comprising one or more measurements of the one or more L1 UE-to-UE CLI measurement resources based on the SCS and the frequency reference point.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by an apparatus comprising: obtaining a configuration or a determination rule that indicates a SCS and a frequency reference point associated with one or more L1 UE-to-UE CLI measurement resources; and sending a channel state feedback report for CLI measurement comprising one or more measurements of the one or more L1 UE-to-UE CLI measurement resources based on the SCS and the frequency reference point.

Clause 2: The method of Clause 1, further comprising: obtaining a report configuration for the channel state feedback report via a first cell; and obtaining the one or more L1 UE-to-UE CLI measurement resources via the first cell.

Clause 3: The method of Clause 2, wherein identifying the configuration or the determination rule comprises obtaining an information element for a downlink BWP of a plurality of downlink BWPs configured on the first cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first physical resource block (PRB#0) of an active downlink BWP of the plurality of downlink BWPs, and the SCS associated with the one or more L1 UE-to-UE CLI measurement resources is based on an SCS of the active downlink BWP or an SCS of an active uplink BWP on the first cell.

Clause 4: The method of Clause 2, wherein identifying the configuration or the determination rule comprises obtaining an information element for a reference downlink BWP of a plurality of downlink BWPs configured on the first cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first physical resource block (PRB#0) of the reference downlink BWP.

Clause 5: The method of Clause 4, wherein the SCS associated with the one or more L1 UE-to-UE CLI measurement resources is based on one or more of: an SCS of the reference downlink BWP, or an SCS of an active downlink BWP on the first cell.

Clause 6: The method of Clause 4, wherein the reference downlink BWP comprises a largest SCS of one or more SCSs configured across the plurality of downlink BWPs.

Clause 7: The method of Clause 2, wherein identifying the configuration or the determination rule comprises obtaining a first information element for the first cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the first cell.

Clause 8: The method of Clause 7, wherein the SCS associated with the one or more L1 UE-to-UE CLI measurement resources is based on one or more of: a configured SCS for the one or more L1 UE-to-UE CLI measurement resources indicated via the one or more parameters, or a determined SCS of an active downlink BWP on the first cell.

Clause 9: The method of Clause 7, further comprising obtaining one or more second information elements comprising the first information element, wherein: the one or more second information elements are associated with one or more cells, respectively, the one or more cells comprise the first cell, and the one or more second information elements comprise one or more of: a dedicated parameter indicating the one or more L1 UE-to-UE CLI measurement resources, or a channel state information measurement configuration parameter indicating the one or more L1 UE-to-UE CLI measurement resources.

Clause 10: The method of Clause 7, wherein the starting physical resource block is based on a multiple of a number of RBs.

Clause 11: The method of Clause 7, further comprising obtaining the one or more L1 UE-to-UE CLI measurement resources of measured RBs in an active downlink BWP.

Clause 12: The method of any one of Clauses 1-11, further comprising:
obtaining a report configuration for the channel state feedback report via a first cell, wherein the report configuration comprises a carrier indication of a second cell; and obtaining the one or more L1 UE-to-UE CLI measurement resources via the second cell.

Clause 13: The method of Clause 12, wherein identifying the configuration or the determination rule comprises obtaining an information element for a downlink BWP of a plurality of downlink BWPs configured on the second cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first physical resource block (PRB#0) of an active downlink BWP of the plurality of downlink BWPs of the second cell, and the SCS associated with the one or more L1 UE-to-UE CLI measurement resources is based on an SCS of the active downlink BWP or an SCS of an active uplink BWP on the second cell.

Clause 14: The method of Clause 12, wherein identifying the configuration or the determination rule comprises obtaining an information element for a reference downlink BWP of a plurality of downlink BWPs configured on the second cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first physical resource block (PRB#0) of the reference downlink BWP of the second cell.

Clause 15: The method of Clause 14, wherein the SCS associated with the one or more L1 UE-to-UE CLI measurement resources is based on one or more of: an SCS of the reference downlink BWP of the second cell, or an SCS of an active downlink BWP on the second cell.

Clause 16: The method of Clause 14, wherein the reference downlink BWP comprises a largest SCS of one or more SCSs configured across the plurality of downlink BWPs of the second cell.

Clause 17: The method of Clause 12, wherein identifying the configuration or the determination rule comprises obtaining a first information element for the second cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the second cell.

Clause 18: The method of Clause 17, wherein the SCS associated with the one or more L1 UE-to-UE CLI measurement resources is based on one or more of: a configured SCS for the one or more L1 UE-to-UE CLI measurement resources indicated via the one or more parameters, or a determined SCS of an active downlink BWP on the second cell.

Clause 19: The method of Clause 17, further comprising obtaining one or more second information elements comprising the first information element, wherein: the one or more second information elements are associated with one or more cells, respectively, the one or more cells comprise the second cell, and the one or more second information elements comprise one or more of: a dedicated parameter indicating the one or more L1 UE-to-UE CLI measurement resources, or a channel state information measurement configuration parameter indicating the one or more L1 UE-to-UE CLI measurement resources.

Clause 20: The method of Clause 17, wherein the starting physical resource block is based on a multiple of a number of RBs.

Clause 21: The method of Clause 17, further comprising obtaining the one or more L1 UE-to-UE CLI measurement resources of measured RBs in an active downlink BWP on the second cell.

Clause 22: The method of any one of Clauses 1-21, wherein the one or more L1 UE-to-UE CLI measurement resources comprise one or more of: L1 UE-to-UE CLI SRS-RSRP measurement resources, or L1 UE-to-UE CLI-RSSI measurement resources.

Clause 23: A method for wireless communications by an apparatus comprising: sending a configuration that indicates a SCS and a frequency reference point associated with one or more L1 UE-to-UE CLI measurement resources; and obtaining a channel state feedback report for CLI measurement comprising one or more measurements of the one or more L1 UE-to-UE CLI measurement resources based on the SCS and the frequency reference point.

Clause 24: The method of Clause 23, further comprising: sending a report configuration for the channel state feedback report via a first cell; and sending the one or more L1 UE-to-UE CLI measurement resources via the first cell.

Clause 25: The method of Clause 24, wherein sending the configuration comprises sending an information element for a downlink BWP of a plurality of downlink BWPs configured on the first cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first physical resource block (PRB#0) of an active downlink BWP of the plurality of downlink BWPs, and the SCS associated with the one or more L1 UE-to-UE CLI measurement resources is based on an SCS of the active downlink BWP or an SCS of an active uplink BWP on the first cell.

Clause 26: The method of Clause 24, wherein sending the configuration comprises sending an information element for a reference downlink BWP of a plurality of downlink BWPs configured on the first cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first physical resource block (PRB#0) of the reference downlink BWP.

Clause 27: The method of Clause 26, wherein the SCS associated with the one or more L1 UE-to-UE CLI measurement resources is based on one or more of: an SCS of the reference downlink BWP, or an SCS of an active downlink BWP on the first cell.

Clause 28: The method of Clause 26, wherein the reference downlink BWP comprises a largest SCS of one or more SCSs configured across the plurality of downlink BWPs.

Clause 29: The method of Clause 24, wherein sending the configuration comprises sending a first information element for the first cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the first cell.

Clause 30: The method of Clause 29, wherein the SCS associated with the one or more L1 UE-to-UE CLI measurement resources is based on one or more of: a configured SCS for the one or more L1 UE-to-UE CLI measurement resources indicated via the one or more parameters, or an SCS of an active downlink BWP on the first cell.

Clause 31: The method of Clause 29, further comprising sending one or more second information elements comprising the first information element, wherein: the one or more second information elements are associated with one or more cells, respectively, the one or more cells comprise the first cell, and the one or more second information elements comprise one or more of: a dedicated parameter indicating the one or more L1 UE-to-UE CLI measurement resources, or a channel state information measurement configuration parameter indicating the one or more UE-to-UE CLI measurement resources.

Clause 32: The method of Clause 29, wherein the starting physical resource block is based on a multiple of a number of RBs.

Clause 33: The method of Clause 29, further comprising sending the one or more L1 UE-to-UE CLI measurement resources of measured RBs in an active downlink BWP.

Clause 34: The method of any one of Clauses 23-33, further comprising:
sending a report configuration for the channel state feedback report via a first cell, wherein the report configuration comprises a carrier indication of a second cell; and sending the one or more L1 UE-to-UE CLI measurement resources via the second cell.

Clause 35: The method of Clause 34, wherein sending the configuration comprises sending an information element for a downlink BWP of a plurality of downlink BWPs configured on the second cell, wherein: the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP, the frequency reference point associated with the one or more L1 UE-to-UE CLI measurement resources is based on a first physical resource block (PRB#0) of an active downlink BWP of the plurality of downlink BWPs of the second cell, and the SCS associated with the one or more L1 UE-to-UE CLI measurement resources is based on an SCS of the active downlink BWP or an SCS of an active uplink BWP on the second cell.

Clause 36: The method of Clause 34, wherein sending the configuration comprises sending an information element for a reference downlink BWP of a plurality of downlink BWPs configured on the second cell, wherein: the information element comprises one or more parameters of at least one L1 UE-to-UE CLI measurement resource of the one or more L1 UE-to-UE CLI measurement resources, and the frequency reference point associated with the one or more L1 UE-to-UE CLI measurement resources is based on a first physical resource block (PRB#0) of the reference downlink BWP of the second cell.

Clause 37: The method of Clause 36, wherein the SCS associated with the one or more L1 UE-to-UE CLI measurement resources is based on one or more of: an SCS of the reference downlink BWP of the second cell, or an SCS of an active downlink BWP on the second cell.

Clause 38: The method of Clause 36, wherein the reference downlink BWP comprises a largest SCS of one or more SCSs configured across the plurality of downlink BWPs of the second cell.

Clause 39: The method of Clause 34, wherein sending the configuration comprises sending a first information element for the second cell, wherein: the first information element comprises one or more parameters of the one or more L1 UE-to-UE CLI measurement resources, and the frequency reference point associated with the one or more L1 UE-to-UE CLI measurement resources is based on a starting physical resource block of the one or more L1 UE-to-UE CLI measurement resources in relation to a first common resource block of a common resource block grid configured for the second cell.

Clause 40: The method of Clause 39, wherein the SCS associated with the one or more L1 UE-to-UE CLI measurement resources is based on one or more of: a configured SCS for the one or more L1 UE-to-UE CLI measurement resources indicated via the one or more parameters, or an SCS of an active downlink BWP on the second cell.

Clause 41: The method of Clause 39, further comprising sending one or more second information elements comprising the first information element, wherein: the one or more second information elements are associated with one or more cells, respectively, the one or more cells comprise the second cell, and the one or more second information elements comprise one or more of: a dedicated parameter indicating the one or more L1 UE-to-UE CLI measurement resources, or a channel state information measurement configuration parameter indicating the one or more L1 UE-to-UE CLI measurement resources.

Clause 42: The method of Clause 39, wherein the starting physical resource block is based on a multiple of a number of RBs.

Clause 43: The method of Clause 39, further comprising sending the one or more L1 UE-to-UE CLI measurement resources of measured RBs in an active downlink BWP on the second cell.

Clause 44: The method of any one of Clauses 23-43, wherein the one or more L1 UE-to-UE CLI measurement resources comprise one or more of: L1 UE-to-UE CLI SRS-RSRP measurement resources, or L1 UE-to-UE CLI-RSSI measurement resources.

Clause 45: One or more apparatuses, comprising: one or more memories comprising executable instructions; and one or more processors configured to execute the executable instructions and cause the one or more apparatuses to perform a method in accordance with any one of Clauses 1-44.

Clause 46: One or more apparatuses configured for wireless communications, comprising: one or more memories; and one or more processors, coupled to the one or more memories, configured to cause the one or more apparatuses to perform a method in accordance with any one of Clauses 1-44.

Clause 47: One or more apparatuses configured for wireless communications, comprising: one or more memories; and one or more processors, coupled to the one or more memories, configured to perform a method in accordance with any one of Clauses 1-44.

Clause 48: One or more apparatuses, comprising means for performing a method in accordance with any one of Clauses 1-44.

Clause 49: One or more non-transitory computer-readable media comprising executable instructions that, when executed by one or more processors of one or more apparatuses, cause the one or more apparatuses to perform a method in accordance with any one of Clauses 1-44.

Clause 50: One or more computer program products embodied on one or more computer-readable storage media comprising code for performing a method in accordance with any one of Clauses 1-44.

Clause 51: One or more apparatuses configured for wireless communications, comprising: a processing system that includes one or more processors and one or more memories coupled with the one or more processors, the processing system configured to cause the one or more apparatuses to perform a method in accordance with any one of Clauses 1-44.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of′ a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
identify a configuration or a determination rule that indicates a subcarrier spacing (SCS) and a frequency reference point associated with one or more Layer 1 (L1) UE-to-UE cross link interference (CLI) measurement resources; and
send a channel state feedback report for CLI measurement comprising one or more measurements of the one or more L1 UE-to-UE CLI measurement resources based on the SCS and the frequency reference point.

2. The apparatus of claim 1, wherein the processing system is configured to cause the UE to:
obtain a report configuration for the channel state feedback report via a first cell; and
obtain the one or more L1 UE-to-UE CLI measurement resources via the first cell.

3. The apparatus of claim 2, wherein to identify the configuration or the determination rule, the processing system is configured to cause the UE to obtain an information element for a downlink bandwidth part (BWP) of a plurality of downlink BWPs configured on the first cell, wherein:
the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP,
the frequency reference point associated with the one or more L1 UE-to-UE CLI measurement resources is based on a first physical resource block (PRB#0) of an active downlink BWP of the plurality of downlink BWPs, and the SCS associated with the one or more L1 UE-to-UE CLI measurement resources is based on an SCS of the active downlink BWP or an SCS of an active uplink BWP on the first cell.

4. The apparatus of claim 2, wherein to identify the configuration or the determination rule, the processing system is configured to cause the UE to obtain an information element for a reference downlink bandwidth part (BWP) of a plurality of downlink BWPs configured on the first cell, wherein:
the information element comprises one or more parameters of at least one L1 UE-to-UE CLI measurement resource of the one or more L1 UE-to-UE CLI measurement resources, and
the frequency reference point associated with the one or more L1 UE-to-UE CLI measurement resources is based on a first physical resource block (PRB#0) of the reference downlink BWP.

5. The apparatus of claim 4, wherein the SCS associated with the one or more L1 UE-to-UE CLI measurement resources is based on one or more of:
an SCS of the reference downlink BWP, or
an SCS of an active downlink BWP on the first cell.

6. The apparatus of claim 4, wherein the reference downlink BWP comprises a largest SCS of one or more SCSs configured across the plurality of downlink BWPs.

7. The apparatus of claim 2, wherein to identify the configuration or the determination rule, the processing system is configured to cause the UE to obtain a first information element for the first cell, wherein:
the first information element comprises one or more parameters of the one or more L1 UE-to-UE CLI measurement resources, and
the frequency reference point associated with the one or more L1 UE-to-UE CLI measurement resources is based on a starting physical resource block of the one or more L1 UE-to-UE CLI measurement resources in relation to a first common resource block of a common resource block grid configured for the first cell.

8. The apparatus of claim 7, wherein the SCS associated with the one or more L1 UE-to-UE CLI measurement resources is based on one or more of:
a configured SCS for the one or more L1 UE-to-UE CLI measurement resources indicated via the one or more parameters, or
a determined SCS of an active downlink bandwidth part (BWP) on the first cell.

9. The apparatus of claim 7, wherein the processing system is configured to cause the UE to obtain one or more second information elements comprising the first information element, wherein:
the one or more second information elements are associated with one or more cells, respectively,
the one or more cells comprise the first cell, and
the one or more second information elements comprise one or more of:
a dedicated parameter indicating the one or more L1 UE-to-UE CLI measurement resources, or
a channel state information measurement configuration parameter indicating the one or more L1 UE-to-UE CLI measurement resources.

10. The apparatus of claim 7, wherein the starting physical resource block is based on a multiple of a number of resource blocks (RBs).

11. The apparatus of claim 7, the processing system is configured to cause the UE to obtain the one or more L1 UE-to-UE CLI measurement resources of measured resource blocks (RBs) in an active downlink bandwidth part (BWP).

12. The apparatus of claim 1, wherein the processing system is configured to cause the UE to:
obtain a report configuration for the channel state feedback report via a first cell, wherein the report configuration comprises a carrier indication of a second cell; and
obtain the one or more L1 UE-to-UE CLI measurement resources via the second cell.

13. The apparatus of claim 12, wherein to identify the configuration or the determination rule, the processing system is configured to cause the UE to obtain an information element for a downlink BWP of a plurality of downlink BWPs configured on the second cell, wherein:
the information element comprises one or more parameters of at least one L1 UE-to-UE CLI measurement resource of the one or more L1 UE-to-UE CLI measurement resources, the at least one L1 UE-to-UE CLI measurement resource having a frequency allocation within the downlink BWP,
the frequency reference point associated with the one or more L1 UE-to-UE CLI measurement resources is based on a first physical resource block (PRB#0) of an active downlink BWP of the plurality of downlink BWPs of the second cell, and
the SCS associated with the one or more L1 UE-to-UE CLI measurement resources is based on an SCS of the active downlink BWP or an SCS of an active uplink BWP on the second cell.

14. The apparatus of claim 12, wherein to identify the configuration or the determination rule, the processing system is configured to cause the UE to obtain an information element for a reference downlink bandwidth part (BWP) of a plurality of downlink BWPs configured on the second cell, wherein:
the information element comprises one or more parameters of at least one L1 UE-to-UE CLI measurement resource of the one or more L1 UE-to-UE CLI measurement resources, and
the frequency reference point associated with the one or more L1 UE-to-UE CLI measurement resources is based on a first physical resource block (PRB#0) of the reference downlink BWP of the second cell.

15. The apparatus of claim 14, wherein the SCS associated with the one or more L1 UE-to-UE CLI measurement resources is based on one or more of:
an SCS of the reference downlink BWP of the second cell, or
an SCS of an active downlink BWP on the second cell.

16. The apparatus of claim 14, wherein the reference downlink BWP comprises a largest SCS of one or more SCSs configured across the plurality of downlink BWPs of the second cell.

17. The apparatus of claim 12, wherein to identify the configuration or the determination rule, the processing system is configured to cause the UE to obtain a first information element for the second cell, wherein:
the first information element comprises one or more parameters of the one or more L1 UE-to-UE CLI measurement resources, and
the frequency reference point associated with the one or more L1 UE-to-UE CLI measurement resources is based on a starting physical resource block of the one or more L1 UE-to-UE CLI measurement resources in relation to a first common resource block of a common resource block grid configured for the second cell.

18. The apparatus of claim 1, wherein the one or more L1 UE-to-UE CLI measurement resources comprise one or more of:
L1 UE-to-UE CLI sounding reference signal (SRS)-reference signal receive power (RSRP) measurement resources, or
L1 UE-to-UE CLI-reference signal strength indicator (RSSI) measurement resources.

19. An apparatus for wireless communications, comprising a processing system that includes one or more processors and one or more memories coupled with the one or more processors, the processing system configured to cause a network entity to:
send a configuration that indicates a subcarrier spacing (SCS) and a frequency reference point associated with one or more Layer 1 (L1) UE-to-UE cross link interference (CLI) measurement resources; and
obtain a channel state feedback report for CLI measurement comprising one or more measurements of the one or more L1 UE-to-UE CLI measurement resources based on the SCS and the frequency reference point.

20. A method for wireless communications by a user equipment (UE) comprising:
identifying a configuration or a determination rule that indicates a subcarrier spacing (SCS) and a frequency reference point associated with one or more Layer 1 (L1) UE-to-UE cross link interference (CLI) measurement resources; and
sending a channel state feedback report for CLI measurement comprising one or more measurements of the one or more L1 UE-to-UE CLI measurement resources based on the SCS and the frequency reference point.
